(19) United States
(12) Patent Application Publication
(10) Pub. No.: US 2026/0161291 A1
(43) Pub. Date: Jun. 11, 2026

(54) Host Controlled Garbage Collection

(71) Applicant: Micron Technology, Inc., Boise, ID (US)

(72) Inventor: Luca Bert, Bologna (BO) (IT)

(21) Appl. No.: 19/179,657

(22) Filed: Apr. 15, 2025

Related U.S. Application Data
(60) Provisional application No. 63/672,656, filed on Jul. 17, 2024.

(51) Int. Cl. G06F 3/06

(52) U.S. Cl. CPC G06F 3/0611; G06F 3/0652; G06F 3/0659; G06F 3/0679

(57) ABSTRACT

A computing system having a host system and a memory sub-system connected to the host system. The memory sub-system is configurable to be prevented from selecting victim reclaim units for garbage collection. The host system is configured to identify a first reclaim unit having residual valid data, and perform operations to cause the residual valid data to be invalidated in the first reclaim unit. The memory sub-system is configured to erase the first reclaim unit in response to a determination that no valid data remains in the first reclaim unit.

### RELATED APPLICATIONS

The present application claims priority to Prov. U.S. patent application Ser. No. 63/672,656 filed Jul. 17, 2024, the entire disclosures of which application are hereby incorporated herein by reference.

### TECHNICAL FIELD

At least some embodiments disclosed herein relate to memory systems in general, and more particularly, but not limited to memory systems configured to support flexible direct placement (FDP).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Flexible direct placement (FDP) is a recently developed technology for a host system to write data into a memory sub-system. When a communication protocol supporting flexible direct placement is used, the host system can specify a data placement directive in a write command sent from the host system to the memory sub-system. The data placement directive instructs the memory sub-system to write data into a reclaim unit having a set of memory cells that are configured to be erased together.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a technique for a host system and a memory sub-system to coordinate efforts related to garbage collection in a memory sub-system according to one embodiment.

FIG. 3 illustrates the monitoring of the usage levels of storage resources in a memory sub-system to trigger operations in a host system to reduce garbage collection operations in a memory sub-system according to one embodiment.

FIG. 4 and FIG. 5 illustrate host operations to reduce garbage collection operations in a memory sub-system according to one embodiment.

FIG. 6 shows reclaiming a unit of storage resources in a memory sub-system according to one embodiment.

FIG. 7 shows residual garbage collection in a memory sub-system according to one embodiment.

FIG. 8 shows a method to reduce garbage collection operations in a memory sub-system according to one embodiment.

FIG. 9 shows a technique to schedule operations of a host system to reduce garbage collection in a memory sub-system with minimal or no communications outside of storage access protocol for flexible direct placement according to one embodiment.

FIG. 10 shows a technique of tracking data placement information in a host system to facilitate operations of host folding according to one embodiment.

FIG. 11 shows a statistical analysis of history data of host folding to determine a condition to trigger host folding according to one embodiment.

FIG. 12 shows a method to schedule operations of a host system to reduce garbage collection in a memory sub-system with minimal or no communications outside of storage access protocol for flexible direct placement according to one embodiment.

FIG. 13 shows a garbage collection manager in a host system configured to obtain time estimates from storage space tenants for host folding according to one embodiment.

FIG. 14 shows a technique to select victim reclaim units based on time estimates from storage space tenants according to one embodiment.

FIG. 15 shows a technique to perform host folding using time estimates from storage space tenants according to one embodiment.

FIG. 16 shows a technique to schedule sending requests to storage space tenants to invalidate data in a reclaim unit according to one embodiment.

FIG. 17 shows a technique to use a predictive model to determine life of data and time to invalidate the data according to one embodiment.

FIG. 18 shows a method to perform host folding based on time estimates of storage space tenants according to one embodiment.

FIG. 19 shows a method to perform host folding based on time estimates from a predictive model according to one embodiment.

FIG. 20 shows garbage collection in a memory sub-system to target a reclaim unit identified by a host system for erasure according to one embodiment.

FIG. 21 shows a garbage collection request from a host system according to one embodiment.

FIG. 22 shows a garbage collection response from a memory sub-system according to one embodiment.

FIG. 23 shows a host system updating data placement information based on a garbage collection response from a memory sub-system according to one embodiment.

FIG. 24 to FIG. 25 show methods to perform garbage collection according to one embodiment.

FIG. 26 to FIG. 28 show techniques to transfer garbage collection control according to some embodiments.

FIG. 29 shows a method to control garbage collection according to one embodiment.

FIG. 30 is a block diagram of an example computer system in which embodiments of the present disclosure can operate.

### DETAILED DESCRIPTION

At least some aspects of the present disclosure are directed to coordination between a host system and a memory sub-system to reduce garbage collection operations in the memory sub-system (e.g., a data storage device, such as a solid-state drive).

A conventional memory sub-system can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

When a block of memory cells has some pages that can be erased and other pages that have valid data, the memory sub-system can perform the operation of garbage collection in which the valid data is copied from the block and written to outside of the block. After the valid data is copied to outside of the block, the entire block can be erased to reclaim the storage resources of the block without data loss. However, copying the valid data from a block for the purpose of erasing the block (so that the previously programmed pages in the block can be again programmed to store new data) increases the activities of programming memory cells to write data and thus leads to increased write amplification (e.g., the ratio between the amount of data being programmed to preserve host data in the storage media of the memory sub-system and the amount of the host data being preserved). Increased write amplification can reduce the performance of the memory sub-system and/or the useful life of the memory cells in the memory sub-system.

A conventional host system is configured to instruct a memory sub-system to store data at locations specified via logical addresses. The memory sub-system can have a flash translation layer configured to map the logical addresses as known to the host system to physical addresses of memory cells in the memory sub-system. As a result, the host system may not be aware which data items are stored in a block having pages configured to be erased together and thus may have fewer options in assisting the reduction of garbage collection and/or write amplification in the memory sub-system.

Flexible direct placement (FDP) is a recently developed technology that supports a communication protocol between a host system and a memory sub-system. With flexible direct placement (FDP), the host system can be aware of which data items are stored together in a unit of memory cells that are configured to be erased together during reclaiming storage resources in the memory sub-system. Such a unit can be referred to as a reclaim unit (RU) (e.g., as in flexible direct placement (FDP)).

Standard protocols for communications between a host system and a memory sub-system, with or without the technology of flexible direct placement (FDP), have not yet been developed to offer sufficient mechanisms that can be used to facilitate cooperation between the host system and the memory sub-system in the reduction of garbage collection in the memory sub-system. An overly aggressive approach implemented to reduce garbage collection can degrade the performance of the system, while the lack of effort to reduce garbage collection can reduce the benefit of write amplification reduction opportunities offered by flexible direct placement (FDP) and/or similar techniques.

At least some aspects of the present disclosure address the above and other deficiencies and challenges by arranging, in a suitable time window, host activities configured to reduce garbage collection in the memory subsystem and thus to harvest the benefit of write amplification reduction without overly aggressive implementations of such activities. The techniques can be implemented with little or no support in standardized protocols for communications between a host system and a memory sub-system, as discussed in further details below.

Flexible direct placement (FDP) (or similar technologies) allows a host system to specify on which reclaim unit handle (RUH) data should be placed by a memory sub-system. A memory sub-system (e.g., a solid-state drive) supporting flexible direct placement (FDP) can expose, to a host system, a number of reclaim unit handles (e.g., 8 to 16 in most common cases but 100's or 1000's are possible). Each reclaim unit handle can independently buffer data received from the host system for writing the data to a separate reclaim unit. Different reclaim unit handles write data to different reclaim units.

For a command sent to write data to the memory sub-system, the host system can specify, via a data placement directive of a write command, on which reclaim unit handle the data to be written should be placed. The memory sub-system can use the data placement directive to write the data on the specific cursor assigned to the reclaim unit handle. The cursor identifies a reclaim unit having a set of memory cells that are grouped together for erasure.

The use of the data placement directive allows the host system to aggregate data of likewise life on the same reclaim unit handle so that they will be deleted at about the same time to minimize the amount of garbage collection, resulting in improvements in both the performance and the endurance of the memory sub-system.

In general, reclaim units configured in a memory sub-system can have a same size known to the host system. A reclaim unit can have a plurality of blocks of memory cells. It is permissible for a host system to write logical blocks randomly into a reclaim unit; and logical blocks from different namespaces can be written into a same reclaim unit. Thus, the logical addresses of data stored in a reclaim unit can be random and/or configured in different namespaces. The flexibility offers improved opportunities for the host system to group data of likewise life for deletion at about the same time.

In general, a host system can have multiple tenants of the storage space offered by the memory sub-system. A tenant can be a writer that controls the life cycle of data being written into the memory sub-system. For example, a tenant can be an application or an instance of the application running for a particular user of the host system. A portion of the operating system running in the host system can be configured to perform data input/output operations on behalf of the tenants via issuing data storage access commands (e.g., read, write, delete, trim) to the memory sub-system.

There can be a mismatch between the possible number of writers and the practical number of reclaim unit handles that can be supported in a memory sub-system within expected performance and endurance requirements (e.g., 8 or 16 can be a most common number). The possible number of writers can scale with the number of cores of the host system (and hence can easily be within the 100's). Thus, many writers (e.g., several tens, possibly 100's) in a host system can write on a same reclaim unit handle (e.g., for data having similar expected life).

When the number of free reclaim units available in the memory sub-system to write data is low, it can trigger the operations of garbage collection in the memory sub-system. Potentially, there can be a race condition on two fronts. On one front, the host system may try to remove data from certain reclaim units before the memory sub-system starts its garbage collection operations. On the other front, the host system and the memory sub-system may not agree on which reclaim unit is to be selected for targeted data removal. For example, the host system may decide, based on information available to the host system, that a particular reclaim unit is a good target for freeing up storage resources; and the memory sub-system may decide, based on its own policies, that another reclaim unit is a good candidate for garbage collection. From the one side, the memory sub-system may be eager to perform garbage collect to reclaim free storage resources usable for the reclaim unit handles; and from the other side, the host system may be eager to start efforts to empty selected reclaim units to free the storage resources before the memory sub-system starts garbage collection, so that write amplification is kept to a minimum.

There can be many writers/tenants in the host system targeting a specific reclaim unit, which makes things more complex, because each writer can only address its portion of data. It is best that the operating system running in the host system coordinates the writers so that the writers using the same reclaim unit complete their operations to invalidate their data in the reclaim unit before the memory sub-system starts its garbage collection operations. This can be quite a complex operation and may take several seconds, which can be long enough that the garbage collection operations in the memory sub-system have kicked in and done the job of copying data to another reclaim unit, just before the writers invalidate them. As the data is now residing in a different reclaim unit as the result of garbage collection in the memory sub-system, invalidating the data does not help write amplification reduction and does not reduce garbage collection.

At least some embodiments disclosed herein provide a clean slate approach that is based on a level of coordination between the host system and the memory sub-system in scheduling the operations related to garbage collection. The techniques disclosed herein allow for orderly execution from tenants in the host system to reduce valid data in reclaim units before the host system relinquishes control to the memory sub-system. The operations can be done in a way that is minimally intrusive to existing protocols (e.g., nonvolatile memory express (NVMe) protocol).

Optionally, some techniques disclosed herein allow the host system and the memory sub-system to agree on which reclaim unit needs to be cleaned for erasure with minimal garbage collection. After the host system completes its operations to clean a reclaim unit, which operations may be referred to as host folding, the host system may relinquish control of garbage collection related operations and the memory sub-system can finalize the garbage collection of copying the remaining valid data (if any) from the targeted reclaim unit to another location for the erasure of the targeted reclaim unit.

In general, there can be many ways to accomplish the orderly execution of operations to reclaim the storage resources of a reclaim unit. However, some approaches would collide with existing protocols (e.g., NVMe protocol). The techniques discussed below involve minimal or no changes to the existing protocols and leverage existing infrastructure.

One simplified approach to coordinate the activities related to garbage collection between a host system and a memory sub-system is to simply disable garbage collection in the memory sub-system by default. Another approach is to add a command in the protocol for communications between host systems and memory sub-systems, where the command can be issued by a host system to stop garbage collection in the memory sub-system that receives the command. When such approaches are used, the memory sub-system may potentially fail to function properly when the host system fails to manage the tenants to free up sufficient reclaim units. In a further approach, the default setting of disabling garbage collection or the command of disabling garbage collection can be automatically reversed by the memory sub-system when it becomes necessary to perform garbage collection in order for the memory sub-system to function properly.

Typically, a memory sub-system is configured to refrain from performing garbage collection until the level of free blocks available in the memory sub-system falls below an internal threshold.

A host system can be configured to estimate or predict such a condition that leads to the onset of garbage collection. For example, the host system can be configured to perform the estimation or prediction based on information available to the host system (e.g., via flexible direct placement).

For example, the host system can determine how many reclaim units are available in the memory sub-system, and how many reclaim units have valid data, and hence the ratio between them. Such a ratio indicates the level of storage resource usages in the memory sub-system. With such an estimate of the level of storage resource usages and a margin below an internal threshold of the memory sub-system, the host system can identify a good operational zone where the host knows that the memory sub-system is not going to perform garbage collection. After a further increase in the level of storage resource usages to beyond the internal threshold of the memory sub-system, garbage collection can happen in the memory sub-system. Host folding can be scheduled within such an operational zone identifiable by the host system with little or no support in the protocol for communications between host systems and memory sub-systems. A trade-off in such an approach is the need for a significant margin below the internal threshold of the memory sub-system, which can be difficult to optimize.

In a further approach, the memory sub-system is configured to report (e.g., via an NVMe log page) information about the level storage resource usages in the memory sub-system. The host system can determine, based on the information reported by the memory sub-system (e.g., via reading the log page), when the memory sub-system is going to start its garbage collection operations. Optionally, the memory sub-system can report the threshold number of reclaim units such that after the threshold number of reclaim units have been used, the memory sub-system is to trigger garbage collection operations. The host system can then determine a more precise margin for the operational zone of host folding, before the memory sub-system starts its garbage collection operations.

Such approaches work not only with memory sub-systems supporting flexible direct placement, but also with memory sub-systems supporting zoned namespace (ZNS). The technique of zoned namespace allows a host system to specify the writing of data into a zone allocated in a namespace, where the memory resources allocated to the zone are grouped together for erasure. Such a zone in zoned namespace can be considered a reclaim unit. However, a zoned namespace does not support random writes in a zone of a namespace and are limited to store data for the particular namespace in which the zone is allocated. Thus, reclaim units implemented via zoned namespace (ZNS) are less flexible than reclaim units implemented via flexible direct placement (FDP).

In one implementation, the host system is configured to monitor the level of storage resource usage in the memory sub-system (e.g., based on the ratio between the number of used reclaim units in the memory sub-system and the number of total reclaim units in the memory sub-system). When the level comes close to the threshold beyond which the memory sub-system is likely to start garbage collection operations, the host system can start its host folding operations.

The host system can be configured to start host folding well in advance of the level reaching the threshold such that the host system has sufficient time to complete its host folding operations to best harvest the benefit of reducing garbage collection in the memory sub-system. For example, the host system can be configured to monitor the write throughput it actually generates for the memory sub-system and determine a time to start its host folding operations such that during the time period of its host folding operations the level of storage resource usage does not reach the threshold.

To start host folding operations, the host system is configured to select a victim reclaim unit to reduce or empty valid data in the reclaim unit so that the victim reclaim unit can be erased with reduced or no residual valid data to be copied in order to reclaim the storage resources of the victim reclaim unit.

For example, based on the information available in the host system, the host system can determine how dirty a reclaim unit is (i.e., how big is the ratio between the size of valid data remaining in the reclaim unit and the storage size of the reclaim unit). Further, the host system can predict how much longer the data in the reclaim unit is needed by the respective tenants. Based on the information about the reclaim units, the host system can select a victim reclaim unit (e.g., a reclaim unit where valid data can be reduced in a short period of time to minimize data to be copied in a garbage collection operation). Since the host system has information about both the logical and physical data affiliation, the host system is in general in a better position to select a victim reclaim unit than the memory sub-system. In contrast, since the memory sub-system knows physical affiliation but not logical affiliation, the effectiveness of a choice made by the memory sub-system can be limited by a partial view.

After a victim reclaim unit is selected, the host system can start host folding operations. For example, the host system can start with instructing the tenants of the victim reclaim unit to reduce their valid data stored in the logical addresses mapped to the victim reclaim unit. Host folding ends with the tenants completing with their responses. This can be a rather slow process; and thus in deciding how soon the host folding needs to start, the host system is to account for the time to be used in completing the host folding operations.

After host folding operations, the memory sub-system can complete its residual garbage collection operations if needed.

In one approach of targeted erasure of reclaim units, the firmware of the memory sub-system is to select a reclaim unit that has the least amount of valid data to be moved. Since the host system has performed operations to reduce valid data in a victim reclaim unit it is likely that the victim reclaim unit selected by the host system is the reclaim unit having no valid data, or the least amount of valid data to be moved. Statistically, the memory sub-system is likely to select victim reclaim units selected by the host system for host folding operations, even without explicit communications between the host system and the memory sub-system in identifying the victim reclaim unit to the memory sub-system. If the memory sub-system for any reason every so often picks a different reclaim unit for erasure, its statistical significance can be minimal.

In a more precise approach of targeted erasure of reclaim units, the host is configured to explicitly inform the memory sub-system about the victim reclaim unit that it has been folded during the host folding operations. Such an approach can include the introduction of a new command in the protocol for communications between host systems and memory sub-systems. A change in the communication protocol is small but rather intrusive. However, the benefit of the change is that the memory sub-system can erase precisely the victim reclaim unit selected by the host system with 100% accuracy.

The advantages of the above discussed techniques are, if the host system operates exactly as described above, almost no garbage collection (e.g., copying valid data for the purpose of erasing memory cells) would happen in the memory sub-system, which thus maximizes the life and performance of the memory sub-system. However, if the host system fails at times to operate as described, the memory sub-system can still fall back on its existing operational mode of garbage collection and thus can be functional in delivering at least at the existing levels.

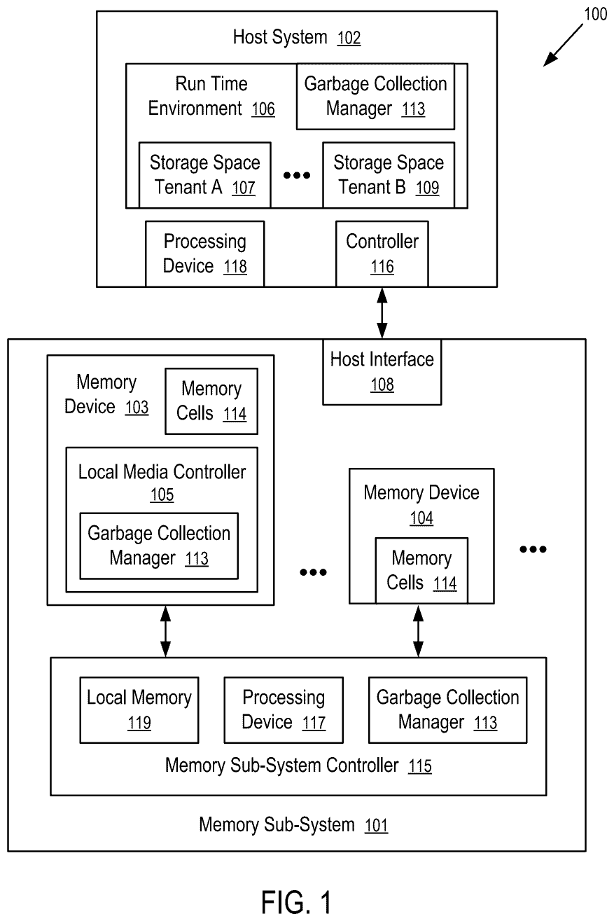

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a garbage collection manager 113 configured to perform operations related to garbage collection in the memory sub-system 101. In some embodiments, the controller 115 in the memory sub-system 101 includes at least a portion of the garbage collection manager 113. In other embodiments, or in combination, the controller 116 and/or the processing device 118 in the host system 102 includes at least a portion of the garbage collection manager 113. For example, the controller 115, the controller 116, and/or the processing device 118 can include logic circuitry implementing the garbage collection manager 113. For example, the controller 115, or the processing device 118 (processor) of the host system 102, can be configured to execute instructions stored in memory for performing the operations of the garbage collection manager 113 described herein. In some embodiments, the garbage collection manager 113 is implemented in an integrated circuit chip disposed in the memory sub-system 101. In other embodiments, the garbage collection manager 113 can be part of firmware of the memory sub-system 101, an operating system of the host system 102, a device driver, or an application, or any combination therein.

For example, the garbage collection manager 113 implemented in the controller 115 and/or 105 of the memory sub-system 101 can be configured to perform garbage collection operations of copying valid data from a reclaim unit to outside of the reclaim unit before erasing the reclaim unit and reclaiming the storage resources of the reclaim unit. Optionally, the garbage collection manager 113 in the memory sub-system 101 can be further configured to communicate, to the host system 102, an indication of the condition that when satisfied, the memory sub-system 101 starts its garbage collection operations. Optionally, the garbage collection manager 113 in the memory sub-system 101 can be further configured to process a command from the host system 102 that identifies a reclaim unit for erasure and thus perform residual garbage collection operations for the reclaim unit if the reclaim unit has remaining valid data. Optionally, the garbage collection manager 113 can be further configured to process a command from the host system 102 that requests the memory sub-systems to stop garbage collection function in general, or start garbage collection in general, or start garbage collection for the erasure of a reclaim unit identified in the command, or delay garbage collection in general for a period of time specified in the command, or delay garbage collection for a reclaim unit identified in the command for a period of time. Optionally, the garbage collection manager 113 can be further configured to store the resource usage information in a log file to assist the host system 102 in the determination of when to start host folding operations. Optionally, the garbage collection manager 113 can be further configured to report to the host system 102 (e.g., via asynchronous event reporting (AER)) a need for host folding.

For example, the garbage collection manager 113 implemented in the host system 102 can be configured to determine when to start host folding operations of communicating with storage space tenants 107, . . . , 109 in the run time environment 106 of the host system 102 to reduce valid data in a victim reclaim unit. The garbage collection manager 113 in the host system 102 can be further configured to track information about the usages of reclaim units in the memory sub-system 101 and select the victim claim unit based on the tracked information. Further, the garbage collection manager 113 can be configured to perform the host folding operations. Optionally, the collection manager 113 can be configured to communicate with the memory sub-system 101 (e.g., via a log file) to determine the current usage level of storage resources and thus whether to select a victim reclaim unit for host folding operation. Optionally, the collection manager 113 can be configured to receive notifications from the memory sub-system 101 (e.g., via asynchronous event reporting (AER)) a need for host folding. Optionally, the collection manager 113 can be configured to communicate with the tenants 107, . . . , 109 to determine an estimate of time to complete folding a reclaim unit and thus a suitable time to start host folding operations. Optionally, the collection manager 113 can be configured to determine an estimate of time to complete folding a reclaim unit without requesting the tenants to provide their estimations. Optionally, the collection manager 113 can be configured to prioritize activities of the tenants to accelerate folding of a victim reclaim unit. Optionally, the collection manager 113 can be configured to send a command to the memory sub-system 101 to identify a reclaim unit for erasure, the start, stop or delay garbage collection in the memory sub-system 101 in general or for a particular reclaim unit identified in the command.

Further details of the operations of the garbage collection managers 113 in the host system 102 and in the memory sub-system 101 are discussed below.

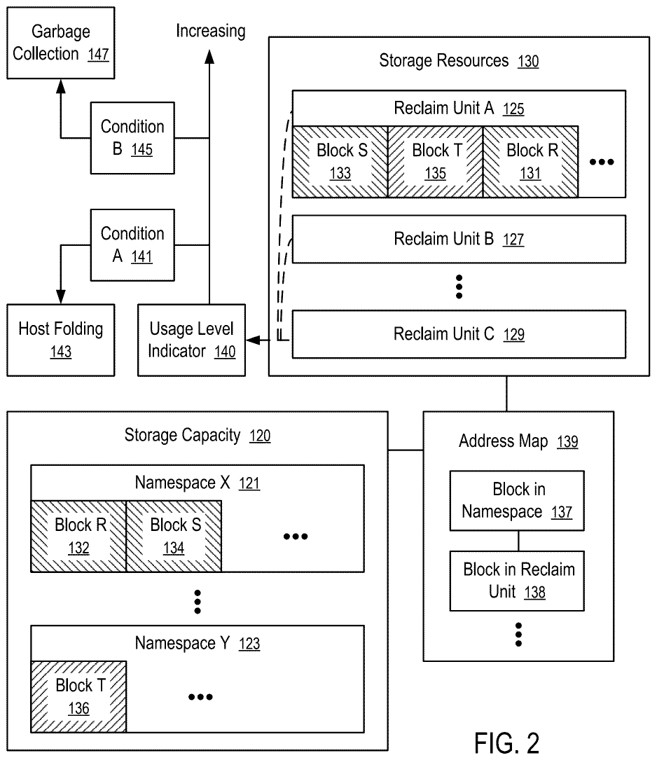

FIG. 2 shows a technique for a host system and a memory sub-system to coordinate efforts related to garbage collection in a memory sub-system according to one embodiment. For example, the technique of FIG. 2 can be implemented in the computing system of FIG. 1 via the garbage collection managers 113.

In FIG. 2, a memory sub-system 101 (e.g., as in FIG. 1) maintains an address map 139 that is configured to identify the mapping between logical blocks (e.g., 137) defined in namespaces (e.g., 121, . . . , or 123) and physical blocks (e.g., 138) of storage resources (e.g., memory cells) that are currently allocated as storage media to store the data of the logical blocks (e.g., 137).

The memory sub-system 101 has a storage capacity 120 (e.g., storage capability provided by memory cells 114 in the memory devices 103, . . . , 104 in the memory sub-system 101 illustrated in FIG. 1). Different portions of the storage capacity 120 can be allocated to different namespaces (e.g., 121, . . . , 123). Within each namespace (e.g., 121 or 123), logical block addresses can be defined sequentially, starting from zero. The namespaces (e.g., 121, . . . , 123) and the logical block addresses defined in the namespaces (e.g., 121, . . . , 123) allow a host system 102 (e.g., as in FIG. 1) to specify the location of writing a block of data into the memory sub-system 101 or reading the block of data.

The memory sub-system 101 has physical storage resources (e.g., memory cells 114 in the memory devices 103, . . . , 104 in the memory sub-system 101 illustrated in FIG. 1). For example, the memory cells 114 in the memory sub-system 101 can be physically structured in pages of memory cells, blocks of pages, and planes of blocks.

The memory sub-system 101 can organize or group of storage resources (e.g., blocks of memory cells) into a reclaim unit (e.g., 125, 127, . . . , or 129) such that the memory cells in a reclaim unit can be erased together, before the storage resources can be programmed again to store new data. For example, the memory cells in each reclaim unit (e.g., 125, 127, . . . , or 129) can be erased without erasing any memory cells outside of the reclaim unit (e.g., 125, 127, . . . , or 129).

To store a block of data at a logical block address (e.g., corresponding to block 134 defined in the namespace 121), the memory sub-system 101 can allocate a block 133 of storage resources in the reclaim unit 125 as the media for the logical block 134. For example, the block 133 of storage resources can be one or more pages of memory cells allocated from one or more blocks of pages. In a typical implementation, the data size of the block 132 in the namespace 121 (e.g., identify via a logical block address defined in the namespace 121) is smaller than the storage capacity of a block of pages that are structured/wired to be erased together. Thus, the block 133 of storage resource in the reclaim unit 125 is not necessarily an entire block of pages.

The data of the logical block 132 in the namespace 121 can be stored in the media/storage resources in the block 133 of the reclaim unit 125. For example, to store the data, one or more pages of memory cells allocated as the block 133 of storage resources 130 can be programmed to have states (e.g., threshold voltage levels) that represent the data stored in the memory cells. The block of data can be retrieved from the media via a read command identifying the logical block address of the block 134 in the namespace 121. For example, the states (e.g., threshold voltage levels) that represent the data stored in the memory cells can be examined in a read operation to determine the data stored in the memory cells.

Instead of using a predetermined relation between the block 134 in the namespace 121 and the block 133 in the reclaim unit 125, the memory sub-system 101 maintains the address map 139 to indicate that the media of the block 134 in the namespace 121 is the block 133 in the storage resources 130. Using the address map 139, the memory sub-system 101 can translate (e.g., via a flash translation layer of the memory sub-system 101) the logical block address of the block 134 in the namespace 121 to the physical address of the block 133 in the storage resources 130.

In one implementation, the memory sub-system 101 supports flexible direct placement (FDP). Using a communication protocol supporting flexible direct placement (FDP), the host system 102 can write blocks (e.g., 134, 136) of different namespaces (e.g., 121, 123) into a same reclaim unit (e.g., 125). Further, the host system 102 can write blocks of a namespace (e.g., 121 or 123) into a reclaim unit (e.g., 125) in a random order, instead of sequentially.

The memory sub-system 101 has a degree of flexibility in allocating blocks of storage resources (e.g., memory cells) to a reclaim unit (e.g., 125). For example, the blocks (e.g., 131, 133, 135) of storage resources do not have to be a contiguous section of memory cells on an integrated circuit die. The blocks (e.g., 131, 133, 135) of storage resources can be allocated from different planes and/or integrated circuit dies. However, the blocks of storage resources allocated to each reclaim unit (e.g., 125) are such that the reclaim unit (e.g., 125) is erasable without erasing any storage resources outside of the reclaim unit (e.g., 125).

Using a protocol supporting flexible direct placement (FDP), the host system 102 can specify a data placement directive in a write command to request the use of a reclaim unit handle operating on the reclaim unit 125 to store data provided by the host system 102. With the data placement directive, the host system 102 can write to the block 134 in the namespace 121, causing the block 133 in the reclaim unit 125 to be used as the media for the block 134 and thus mapped accordingly in the address map 139. For example, in the address map 139, block 137 can identify block 134 in the namespace 121; and the associated block 138 can identify the physical block 133 in the reclaim unit 125 as the media of the logical block 134 in the namespace.

Subsequently, the host system 102 can use the same reclaim unit handle to write to the block 136 in a different namespace 123, causing the subsequent block 135 in the reclaim unit 125 to be used as the media for the block 136 in the namespace 123. Since the host system 102 uses the same reclaim unit handle to write the block 134 in the namespace 121 and the block 136 in the namespace 123, the host system 102 knows that the blocks 134 and 136 are stored into the same reclaim unit 125. For example, when the host system 102 determines that the blocks 134 and 136 have likewise life, the host system 102 can use the same reclaim unit handle to place their data together in a same reclaim unit 125. For example, the data of the blocks 134 and 136 can be from different storage space tenants (e.g., 107, 109 in FIG. 1).

Subsequently, the host system 102 can further use the same reclaim unit handle to write to the block 132 in the namespace 121, causing the block 131 in the reclaim unit 125 to be used as the media for the block 132. Thus, the reclaim unit 125 can host data of different namespaces (e.g., 121, 123) in a random order.

In one implementation, an indicator 140 of usage level of the storage resources 130 is used to coordinate the operations of the garbage collection managers 113 in the host system 102 and in the memory sub-system 101, with little or no additional communications outside of the current protocol for communications between host systems and memory sub-systems (e.g., NVMe protocol).

For example, the indicator 140 can be configured to show the ratio of the number of reclaim units that have valid data and the total number of reclaim units in the storage resources 130 of the memory sub-system 101. As the usage level indicator 140 increases, the number of free reclaim units usable to write new data decreases. When the usage level indicator 140 increases to meet one condition 141 (e.g., a lower threshold, or watermark of usage level), the host system 102 can start its operations of host folding 143 (e.g., communicating with the storage space tenants to request the tenants to perform operations to reduce valid data in a victim reclaim unit (e.g., 125)). It can take a period of time for the host folding 143 to be effective in reducing valid data in a victim reclaim unit (e.g., 125) for a successful completion. In some instances, when valid data cannot be completely removed from the victim reclaim unit (e.g., 125) within a predetermined time window allocated for the operations of host folding 143, the operations of host folding 143 can be terminated to accept the achieved reduction as a best-effort result. Subsequently, as the indicator 140 increases to another condition (e.g., a higher threshold, or watermark of usage level), the memory sub-system 101 can start garbage collection 147, while the host system 102 refrains from operations of host folding 143 to avoid a racing condition.

During the period of host folding 143, the usage level indicator 140 can continue to increase. When the usage level indicator 140 increases to meet another condition 145 (e.g., a threshold higher than the threshold of the condition 141), the memory sub-system 101 can start its operations of garbage collection 147 (e.g., copying valid data from the reclaim unit 125 to another reclaim unit (e.g., 129) for the erasure of the reclaim unit 125).

To coordinate the host folding 143 in the host system 102 and the garbage collection 147 in the memory sub-system 101, the conditions 141 and 145 are configured such that the host folding 143 and the garbage collection 147 are not performed concurrently. For example, when the usage level indicator 140 reaches the condition 145, the garbage collection manager 113 in the host system 113 can pause or stop its operations of host folding 143 and thus relinquishes control to the garbage collection manager 113 in the memory sub-system 113. Such an arrangement reduces and/or avoids the race condition discussed above, while the benefit of write amplification reduction is increased or maximized.

In one embodiment, the conditions 141 and 145 correspond to watermarks of the usage of the storage resources 130 in triggering host folding 143 in the host system 102 and triggering garbage collection 147 in the memory sub-system 101 respectively. The memory sub-system 101 and the host system 102 can communicate with each other to set /r negotiate the watermarks. Optionally, the memory sub-system 101 can report the condition 145 to the host system 102 to allow the host system 102 to determine/select the condition 141. Alternatively, the conditions 141 and 145 can be separately coded into the host system 102 and the memory sub-system 101 based on statistical data. Alternatively, the host system 102 can select the conditions 141 and 145 and request the memory sub-system 101 to refrain from garbage collection 147 before the indicator 140 reaches the condition 145.

Preferably, the conditions 141 and 145 are selected such that the time gap for the usage level indicator 140 to increase from the condition 141 to the condition 145 is minimized (e.g., to reduce impacts on the normal operations of the host system 102), but is sufficient to allow the host folding 143 to maximize the benefit of effectively reducing as much valid data as possible from one or more reclaim units.

For example, under a typical operating condition of the computing system 100 having the host system 102 and the memory sub-system 101, different selections of the condition 141 relative to the condition 145 (e.g., having gaps of different sizes between the conditions 141 and 145) can be used to test the cost and benefit of the selections. A cost function can be used to penalize the cost of starting host folding 143 too soon, and to reward the benefit of write amplification reduction resulting from reduced valid data in one or more victim reclaim units (e.g., 125). From the test runs/selections, a statistically optimized selection of the condition 141 relative to the condition 145 can be used for subsequent triggering of the operations of host folding 143. For example, the statistically optimized selection of the condition 141 is selected through minimizing the cost function against the test runs/selections.

For example, when a selection of the condition 141 is used to trigger the operations of host folding 143, the garbage collection manager 113 in the host system 102 can record the time gap for the usage level indicator 140 to increase from the condition 141 to the condition 145. Optionally, the garbage collection manager 113 in the host system 102 can further record the time gap between the completion of host folding 143 and the indicator 140 increasing to the condition 145; and the this time gap can be penalized more heavily than the time gap between the conditions 141 and 145.

Further, the host system 102 can record the size of valid data that has been successfully removed from one or more victim reclaim units during the host folding 143. The time gap (or time gaps) and the data size can be used as in the cost function to quantify the cost and benefit of the selection of the condition 141 in one instance of host folding 143. Data points corresponding to multiple instances of host folding 143 triggered by the same selection of the condition 141 can be collected. Further, data points corresponding to multiple instances of host folding 143 triggered by different selections of the condition 141 can be collected. From the collected data points, a statistically optimized selection of the condition 141 that minimizes the cost function can be computed.

Optionally, the tests/selections can be repeated for different patterns of operation conditions of the computing system 100. Thus, when the pattern of the current operating conditions changes, the corresponding statistically optimized selection of the condition 141 for the current pattern can be looked up and deployed.

In some implementations, after the garbage collection manager 113 in the host system 102 completes its operations of host folding 143 targeting a victim reclaim unit (e.g., 125), the usage level indicator 140 is above the condition 141 but not yet reaching the condition 145 for garbage collection 147. In such situations, the garbage collection manager 113 in the host system 102 can further select another victim reclaim unit (e.g., 127) for its host folding operation 143, until the usage level indicator 140 reaches the condition 145.

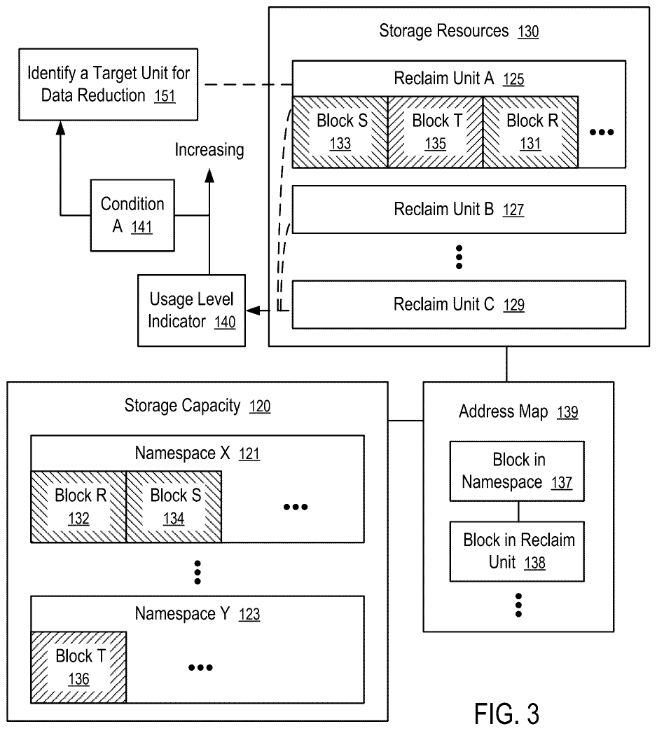

FIG. 3 illustrates the monitoring of the usage levels of storage resources in a memory sub-system to trigger operations in a host system to reduce garbage collection operations in a memory sub-system according to one embodiment. For example, the monitoring as illustrated in FIG. 3 can be implemented as part of the technique of FIG. 2.

For example, the usage level indicator 140 can be monitored to determine whether it satisfies the condition 141 (e.g., a condition of the indicator 140 being higher than a lower threshold, as in FIG. 2).

In response to the usage level indicator 140 being determined to meet the condition 141, a victim reclaim unit (e.g., 125) can be identified 151 as a target unit for reduction of valid data during host folding 143.

For example, the garbage collection manager 113 in the host system 102 can be configured to track the amounts of valid data remaining in reclaim units (e.g., 125, 127, . . . , 129) in the storage resources 130 of the memory sub-system 101. Further, the garbage collection manager 113 in the host system 102 can be configured to estimate how close the valid data is expected to be invalidated by respective tenants (e.g., 107, . . . , 109). Based on the information about the valid data remaining in the reclaim units (e.g., 125, 127, . . . , 129), the garbage collection manager 113 in the host system 102 can select a victim reclaim unit that is likely to have a least amount of residual valid data after the host folding 143 and before the usage level indicator 140 reaches the next condition 145 (e.g., in FIG. 2) for garbage collection 147.

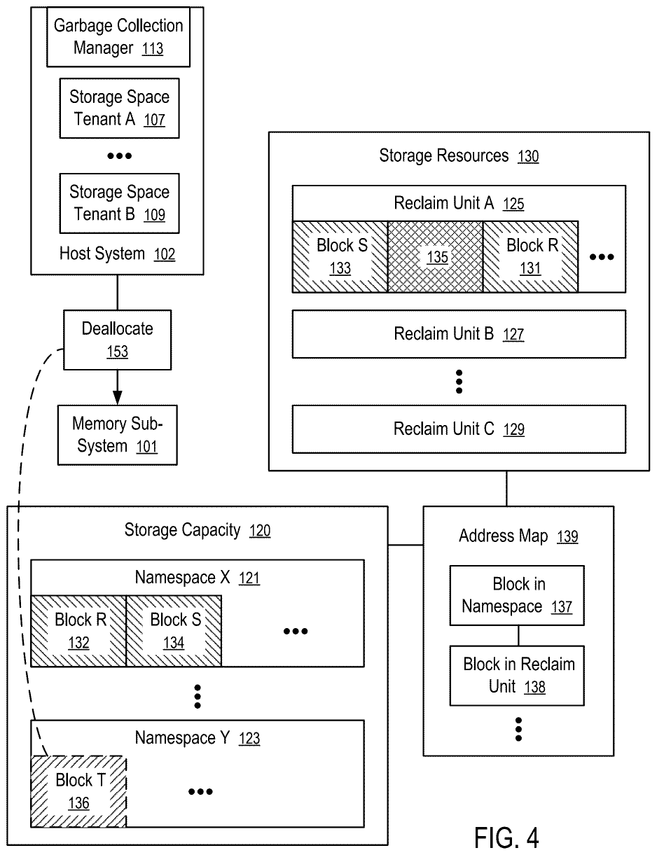

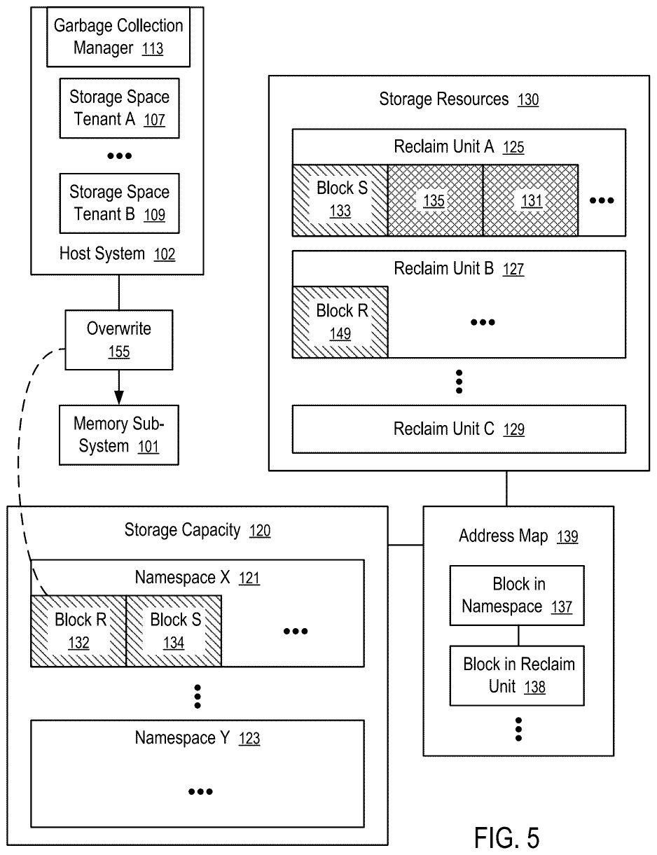

After the selection of a victim reclaim unit (e.g., 125), the garbage collection manager 113 in the host system 102 can perform the operations of host folding 143 as illustrated in FIG. 4 and FIG. 5.

FIG. 4 and FIG. 5 illustrate host operations to reduce garbage collection operations in a memory sub-system according to one embodiment.

During the operations of host folding 143, the garbage collection manager 113 in the host system 102 identifies owners/tenants of the blocks (e.g., 132, 134, 136) of data stored in the victim reclaim unit 125. The owners can be a subset of storage space tenants 107, . . . , 109 in the host system 102. The garbage collection manager 113 in the host system 102 communicates with the owners to expedite the invalidation of the valid data in the victim reclaim unit 125 before the indicator 140 reaches the next condition 145 for garbage collection 147.

As an example, the garbage collection manager 113 in the host system 102 determines that the owner of the block 136 in the namespace 123 is the storage space tenant 109. Thus, the garbage collection manager 113 requests the tenant 109 to expedite invalidation of the data in the block 136 in the namespace 123 within a specified period of time.

In response, the tenant 109 may complete its use of the data stored in the block 136 and cause the garbage collection manager 113 in the host system 102 to issue a command to the memory sub-system 101 to deallocate 153 (or delete) the block 136, as illustrated in FIG. 4. As a result, the memory sub-system 101 can store data indicating that the block 135 of storage resources now does not store valid data (and thus can be erased).

As another example, the garbage collection manager 113 in the host system 102 determines that the owner of the blocks 132 and 134 in the namespace 121 is the storage space tenant 107. Thus, the garbage collection manager 113 requests the tenant 107 to expedite invalidation of the data in the blocks 132 and 134 in the namespace 121 within a specified period of time.

In response, the tenant 109 may complete its use of the current data stored in the block 136, generate new data for the block 136 in the namespace 121, and cause the garbage collection manager 113 in the host system 102 to overwrite 155 the block 132, as illustrated in FIG. 5. Since the block 131 in the reclaim unit 125 has not yet been erased, the block 131 of storage resources cannot be used to store the new data for the block 132 in the namespace 121. Thus, the memory sub-system 101 allocates a block 149 of storage resources from another reclaim unit 127 as the current media allocated for the block 132 in the namespace 121; and the address map 139 is updated accordingly to indicate the association between the block 132 in the namespace 121 and the block 149 in the reclaim unit 127. As a result, the memory sub-system 101 can store data indicating that the block 131 of storage resources now does not store valid data (and thus can be erased).

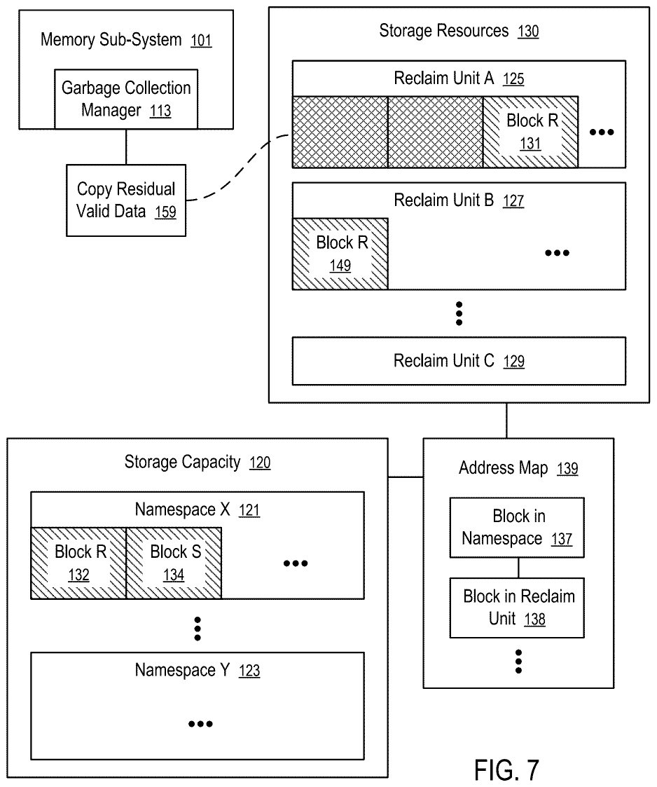

In some instances, the storage space tenant 107 may not be able to invalid all of its data in the blocks 132 and 134 within the specified period of time as requested by the garbage collection manager 113 in the host system 102. Thus, the reclaim unit 125 can have residual valid data to be copied, by the garbage collection manager 113 in the memory sub-system 101, to outside of the victim reclaim unit 125, as illustrated in FIG. 7.

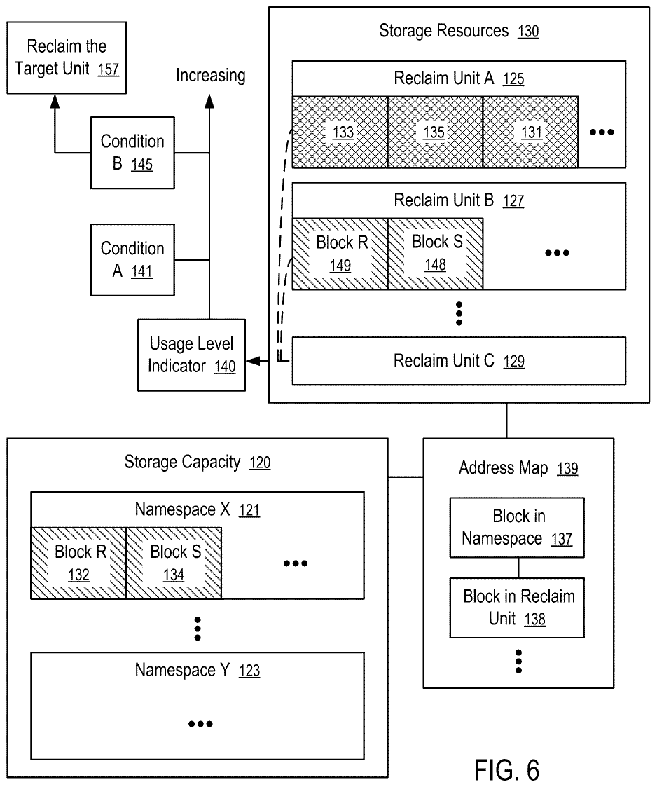

In some instances, the storage space tenant 107 can invalid all of its data in the blocks 132 and 134 within the specified period of time as requested by the garbage collection manager 113 in the host system 102. Thus, the blocks 131, 133, and 135 of storage resources in the memory sub-system 101 can be marked as storing no valid data (and thus can be erased). Subsequently, when the usage level indicator 140 reaches the condition 145 for garbage collection 147, the memory sub-system 101 can erase the reclaim unit 125 without copying data from the blocks 131, 133, 135, as illustrated in FIG. 6.

FIG. 6 shows reclaiming a unit of storage resources in a memory sub-system according to one embodiment.

In FIG. 6, the blocks 131, 133, 135 have no valid data (e.g., after tenant 107 having overwrite 155 new data into blocks 132 and 134 to cause the blocks 132 and 134 of the namespace 121 to have storage resources allocated from another reclaim unit 127). Thus, the garbage collection manager 113 in the memory sub-system 101 can erase the reclaim unit 125 without copying data from the blocks 131, 133, and 135.

In some instances, the operations of host folding 143 can completely evacuate the reclaim unit 125, leaving no valid data in the reclaim unit 125. As a result, the memory sub-system 101 can simply erase the reclaim unit 125 to reclaim 157 the storage resources of the target unit.

In some instances, the operations of host folding 143 can fail to completely evacuate the reclaim unit 125, leaving residual valid data in one or more blocks (e.g., 131) in the reclaim unit 125. Once the condition 145 is reached, the garbage collection manager 113 in the memory sub-system 101 can copy the residual valid data from the reclaim unit 125 to another reclaim unit (e.g., 127) to erase the reclaim unit 125, as illustrated in FIG. 7.

FIG. 7 shows residual garbage collection in a memory sub-system according to one embodiment.

In FIG. 7, after the usage level indicator 140 reaches the condition 145 for garbage collection 147, the garbage collection manager 113 determines that block 131 in the reclaim unit 125 still stores valid data for the block 132 in the namespace 121. To erase the reclaim unit 125 without losing data, the garbage collection manager 113 in the memory sub-system 101 can copy 159 residual valid data from the block 131 of storage resources in the reclaim unit 125 to another reclaim unit (e.g., 127) and update the address map 139 (e.g., to use block 148 in reclaim unit 127 as the storage media of block 132 in the namespace 121, as illustrated in FIG. 6). After no valid data remains in the reclaim unit 125, the garbage collection manager 113 in the memory sub-system 101 can erase the reclaim unit 125 (e.g., in a way similar to what is illustrated in FIG. 6).

Using the techniques of FIG. 2 to FIG. 7, the benefit of write amplification reduction can be maximized without the host system 102 and the memory sub-system 101 racing against each other to perform operations related to garbage collection.

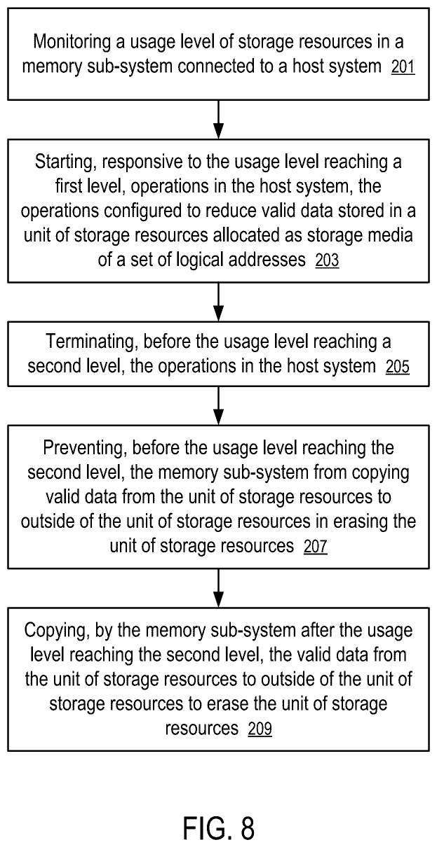

FIG. 8 shows a method to reclaim storage space occupied by proof of space plots in a memory sub-system according to one embodiment. The method of FIG. 8 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 8 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 8 can be implemented using the garbage collection managers 113 of FIG. 1 to perform the operations illustrated in FIG. 2 to FIG. 7.

For example, the storage resources 130 of the memory sub-system 101 can be grouped/organized in the form of reclaim units 125, 127, . . . , 129 that are visible to the host system 102. The host system 102 can use data placement directives specified in write commands sent from the host system 102 to the memory sub-system 101 to control the placement of data to be written into reclaim units 125, 127, . . . , 129.

At block 201, the method of FIG. 8 includes monitoring a usage level of storage resources 130 in a memory sub-system 101 connected to a host system 102.

For example, when a communication protocol supporting flexible direct placement (FDP) is used for the host system 102 to write data into the memory sub-system 101, the host system 102 can evaluate an indicator 140 of the usage level of the storage resources 130 in the memory sub-system 101. The indicator 140 can be evaluated by the host system 102 independently from the memory sub-system 101 monitoring the usage level of its storage resources 130.

At block 203, the method includes starting, responsive to the usage level reaching a first level (e.g., corresponding to a condition 141 associated with a lower threshold or watermark for the usage level of the storage resources 130 in the memory sub-system 101), operations of host folding 143 in the host system 102. The operations of host folding 143 are configured to reduce valid data stored in a unit of storage resources (e.g., a reclaim unit 125) allocated as storage media of a set of logical addresses.

For example, the unit of storage resources can be a reclaim unit in a technique of flexible direct placement.

For example, the host system 102 can determine, based on data placement directives provided by the host system 102 in write commands sent from the host system 102 to the memory sub-system 101, the usage level reaching the first level.

For example, for the operation of host folding 143 in the host system 102, the host system 102 can identify, based on the data placement directives provided by the host system 102 in the write commands sent from the host system 102 to the memory sub-system 101, the set of logical addresses having the unit of storage resources allocated in the memory sub-system 101 as the storage media of the set of logical addresses.

For example, the set of logical addresses can include first logical block addresses (e.g., for blocks 132, 134) in a first namespace (e.g., 121) of a storage capacity 120 of the memory sub-system 101 and second logical block addresses (e.g., of block 136) in a second namespace (e.g., 123) of the storage capacity 120 of the memory sub-system 101. For example, the first logical block addresses (e.g., of the blocks 132, 134) can be non-sequential in the first namespace (e.g., 121).

At block 205, the method includes terminating, before the usage level reaching a second level (e.g., corresponding to a condition 145 associated with a higher threshold or watermark for the usage level of the storage resources 130 in the memory sub-system 101), the operations of host folding 143 in the host system 102.

For example, the host system 102 can determine, based on the data placement directives provided by the host system 102 in the write commands sent from the host system 102 to the memory sub-system 101, the usage level reaching the second level for the termination of the operations of host folding 143 in the host system 102.

In some instances, the operations of host folding 143 complete naturally before the usage level reaching the second level. In other instances, the host system 102 stops the operations of host folding 143 once the usage level approaches, reaches, or exceeds the second level to avoid concurrent efforts in reducing valid data in the unit of storage resources allocated in the memory sub-system 101 as the storage media of the set of logical addresses.

For example, during the operations of host folding 143, a garbage collection manager 113 running in the host system 102 can communicate with storage space tenants (e.g., 107, . . . , 109) running in the host system 102 to reduce valid data stored in the unit of storage resources allocated as storage media of the set of logical addresses.

For example, during the operations of host folding 143, reduction of valid data stored in the unit of storage resources can be via at least one of: a storage space tenant deleting data from a logical address among the set of logical addresses; a storage space tenant deallocating a logical address among the set of logical addresses; and a storage space tenant writing to a logical address among the set of logical addresses.

At block 207, the method includes preventing, before the usage level reaching the second level, the memory sub-system 101 from copying valid data from the unit of storage resources to outside of the unit of storage resources in erasing the unit of storage resources during the operations of garbage collection 147 in the memory sub-system 101.

In one implementation, the host system 102 can send a command to the memory sub-system 101 to instruct the memory sub-system 101 to pause garbage collection 147 in general, or to pause garbage collection 147 of the unit of storage resources (e.g., reclaim unit 125) specifically. In another implementation, the garbage collection manager 113 in the firmware of the memory sub-system 101 is configured to refrain from performing garbage collection 147 in general before usage level reaching the second level.

At block 209, the method includes copying, by the memory sub-system 101 after the usage level reaching the second level, the valid data from the unit of storage resources to outside of the unit of storage resources to erase the unit of storage resources. After the copying, the memory sub-system 101 can erase the unit of storage resources (e.g., reclaim unit 125) so that the storage resources in the erased unit can be programmed again to store new data provided by the host system 101 via write commands.

For example, after the usage level reaching the second level, the memory sub-system 101 can determine whether there is residual valid data in the unit of storage resources and, if so, copy the residual valid data from the unit of storage resources to outside of the unit of storage resources to erase the unit of storage resources.

It can be advantageous to arrange sequential executions of host folding 143 and garbage collection 147 at appropriate time instances with no or minimal communications outside of storage access protocols of flexible direct placement (FDP). To arrange the sequential executions, the garbage collection managers 113 in the memory sub-system 101 and in the host system 102 can be configured to separately and independently monitor the indicator 140 of usage level according to information available to the memory sub-system 101 and the host system 102 respectively. The garbage collection manager 113 in the memory sub-system 101 can be configured to start its garbage collection 147 according to a statistically determined condition 145 to avoid performance degradation due to the lack of sufficient free storage resources ready for programming. Separately and independently, the garbage collection manager 113 in the host system 102 can start its host folding 143 according to another statistically determined condition 141 to best harvest the benefit of write amplification reduction with least disturbance to other tasks.

In general, host folding 143 can start any time before garbage collection 147 starts in the memory sub-system 101. However, starting host folding 143 too soon can disturb the normal executions of the storage space tenants 107, . . . , 109 without added benefit in write amplification reduction. On the other hand, if starting host folding 143 too late, the storage space tenants 107, . . . , 109 may not have sufficient time to perform operations to reduce the valid data in a victim reclaim unit.

To maximize the benefit of write amplification reduction and reduce impacts of host folding 143, it can be desirable to delay the onset of host folding 143 to a point that still provides a sufficient time period for host folding 143 to maximize the invalidation of data stored in a victim reclaim unit within a reasonable time window. The time window can be adjusted via testing the cost and benefit of starting host folding 143 under different conditions and determining a statistically optimized window between the conditions 145 and 141 from the test results.

Based on the data placement directive used by the host system 102 to instruct the memory sub-system 101 to place data into reclaim units, the garbage collection manager 113 in the host system 102 can have sufficient information to determine an indicator 140 of the usage level of reclaim units 125, 127, . . . , 129 in the memory sub-system 101 without assistance/communications from the memory sub-system 101.

For example, reclaim unit usage in the memory sub-system 101 can be estimated by the host system 102 as a ratio between the number of free reclaim units available in the memory sub-system 101 and the total number of reclaim units available in the data storage. The total number of reclaim units available in the data storage can be determined or estimated based on the storage capacity 120 of the memory sub-system 101 and the storage capacity of one reclaim unit in the memory sub-system 101. When the host system 102 writes to the memory sub-system 101 an amount of data that is equal to the storage capacity of one reclaim unit, the host system 102 can decrease the count of free reclaim units by one (and thus increase the count of in-use reclaim units by one). After the host system 103 performs host folding 143 to reduce or evacuate a victim reclaim unit, the host system 102 can assume that the victim reclaim unit can be reclaimed by the garage collection manager 113 in the memory sub-system 101 when a free reclaim unit is needed; and thus, the host system 102 can increase the count of free reclaim units by one (and thus decrease the count of reclaim units in use by one). Thus, the host system 102 can determine the indicator 140 of usage level of reclaim units with sufficient accuracy without assistance from the memory sub-system 101.

For improved accuracy, the host system 103 can track the size of the residual valid data remaining in the victim reclaim unit and count the size as new data written into the memory sub-system, since the memory sub-system 101 is to copy the residual valid data during garbage collection 107. Alternatively, the host system 103 can send read commands to retrieve the residual valid data and write commands to save the valid data at another reclaim unit having data of similar life, which has an effect similar to the memory sub-system 101 copying the data during garbage collection 147.

Optionally, the host system 101 can track the indicator 140 of the usage level of reclaim units in the memory sub-system as a radio between the number of total free capacity in reclaim units in the memory sub-system 101, and the total storage capacity 120 of the reclaim units 125, 127, . . . , 129 in the memory sub-system 101.

In general, different types of indicators (e.g., 140) of the usage level of storage resources 130 in the memory sub-system 101 can be monitored for the triggering of host folding 143. Since it is not necessary to trigger host folding 143 at a precision instance, the accuracy requirement for the indicator 140 used to trigger the host folding is not high. Thus, the host system 140 can use an indicator that is easy to track and compute.

With minimal communications outside of flexible direct placement (FDP), garbage collection managers 113 in the host system 102 and in the memory sub-system 101 can separately and independently monitor the usage level of the reclaim units (and even use different types/definitions of usage level indicators).

The garbage collection manager 113 in the memory sub-system 101 can be configured to skip garbage collection before its monitored reclaim unit usage level reaches a condition 145 that triggers garbage collection 147 in the memory sub-system 101.

The garbage collection manager 113 in the host system 102 can be configured to separately monitor the reclaim unit usage level based on write commands sent from the host system 102 to the memory sub-system 101, without additional communications outside of the protocol of flexible direct placement (FDP).

In one implementation, a statistically determined margin from the condition 145 is used to select the condition 141 used in the host system 101 to trigger host folding 143.

During host folding 143, the garbage collection manager 113 in the host system 102 communicates with storage space tenants 107, . . . , 109 to promote the expiration of data stored in one or more victim reclaim units identified by the host system 102. For example, a storage space tenant 107 or 109 can be a user process spawned by an application running in the host system 102 (or another computing device that accesses the host system 102 to use the storage space controlled by the host system 102 over a computer network). For example, a storage space tenant 107 or 109 can be a kernel process spawned by an operating system running in the host system 102, or a thread spawned by a process for execution on a core of a central processing unit (CPU), etc.

It takes a period of time for the host folding 143 to invalid a significant amount of valid data remaining in one or more victim reclaim units. For example, it may take minutes for the storage space tenants (e.g., 107 or 109) to complete operations that invalidate the remaining data in the victim reclaim units; and during such a time period, the memory sub-system 101 can receive and/or process thousands or millions storage access requests, depending on the current operating condition of the host system. Thus, the amount of data that may be written during the time period between the conditions 141 and 145 can have large statistical variations.

In general, the margin from the condition 145 of triggering garbage collection 147 to the condition 141 for triggering host folding 143 can be selected to balance the need to avoid unnecessary operations of host folding 143, and the benefit of maximized data invalidation in the victim reclaim units. Due to the large statistical variations in the amount of data that may be written into the memory sub-system after the triggering of host folding, a margin that is statistically most likely to allow host folding 143 to complete naturally can be used to set the condition 141 for triggering host folding 143.

For example, a data center may tweak the margin to minimize a function of costs associated with folding and costs associated with write amplification resulting from garbage collection to determine an optimize the margin for a type of applications running using the storage space of the memory sub-system 101.

For example, the margin can be dependent on a current pattern of activities of the storage space tenants (e.g., 127, . . . , 129), in view of different pairs of activity pattern and statistically optimized margins recognized from historic records of host folding 143 performed in the past.

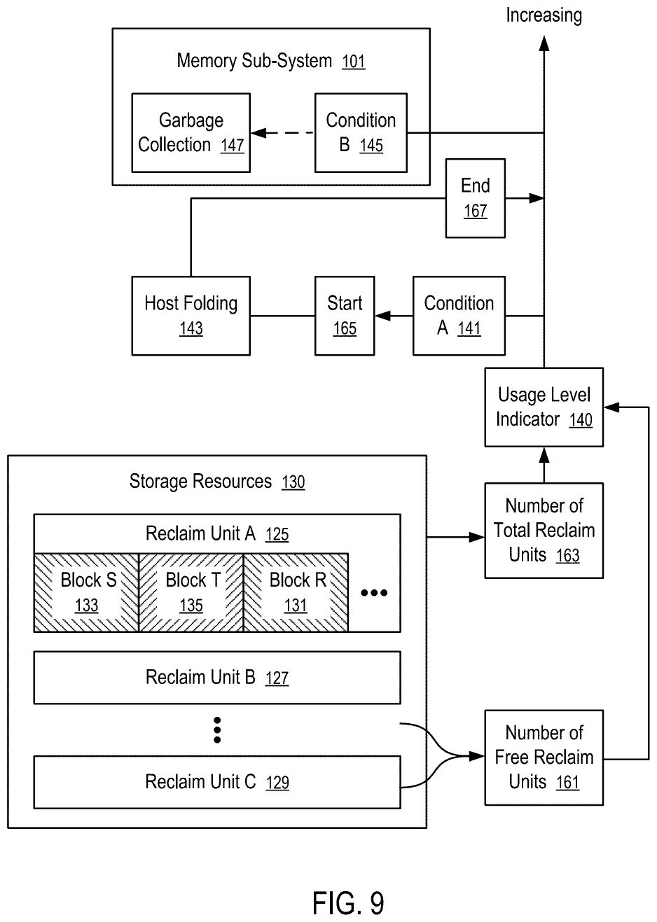

FIG. 9 shows a technique to schedule operations of a host system to reduce garbage collection in a memory sub-system with minimal or no communications outside of storage access protocol for flexible direct placement according to one embodiment. For example, the operations of host folding 143 of FIG. 2 to FIG. 5 can be implemented using the technique of FIG. 9.

In FIG. 9, the garbage collection managers 113 in the host system 102 and the memory sub-system 101 are separately configured to avoid the need to communicate outside of storage access protocol for flexible direct placement (FDP).

For example, the garbage collection manager 113 in the memory sub-system 101 can monitor an indicator 140 of usage level of reclaim units 125, 127, . . . , 129 to trigger operations of garbage collection 147.

Independently from the memory sub-system 101 monitoring the indicator 140 of usage level of reclaim units 125, 127, . . . , 129, the garbage collection manager 113 in the host system 102 can monitor a version of the indicator 140 based on information readily available to the host system 102 (e.g., based on write communicates made using the storage access protocol for flexible direct placement (FDP)).

For example, the host system 102 can count the number 161 of free reclaim units in the memory sub-system 101 based on the amount of data written by the host system 102 into the memory sub-system 101, since the storage size of one reclaim unit in the memory sub-system 101 is known to the host system 102. For example, when an amount of new data is written into the memory sub-system 101, the number 161 of free reclaim units in the memory sub-system 101 can be reduced by the amount divided by the storage size of one reclaim unit. Based on the number 163 of total reclaim units in the memory sub-system 101 and the number 161 of free reclaim units 161 in the memory sub-system 101, the garbage collection manager 113 in the host system 102 can compute the indicator 104 without communications performed outside of storage access protocol for flexible direct placement (FDP).

After the condition 141 is set for the garbage collection manager 113 in the host system 102, the garbage collection manager 113 can start 165 the operations of host folding 143 when the indicator 140 satisfies the condition 141. The condition 141 can be selected such that the operations of host folding 143 end 167 before the indicator 140 reaches the condition 145 in most instances statistically.

Optionally, the condition 145 is specified for the garbage collection manager 113 in the host system 102 such that host folding 143 can occasionally fail to complete before the indicator 140 reaching the condition 145; and the garbage collection manager 113 in the host system can be configured to terminate the operations of host folding 143 upon the indicator 140 reaching the condition 145.

In some implementations, after the end 167 of host folding 143, the garbage collection manager 113 in the host system 102 can assume that the memory sub-system 101 will erase the victim reclaim units and thus increase the number 161 of free reclaim units by the number of the victim reclaim units being invalidated during host folding 143.

Optionally, the host system 102 can be configured to completely invalidate data in a victim reclaim unit to allow the memory sub-system 101 to erase the victim reclaim unit without garbage collection for the victim reclaim unit (e.g., there is no residual valid data remaining in the victim reclaim unit after host folding 143).

For example, when a storage data tenant (e.g., 107 or 109) determines that the data in a block 132 in a namespace 121 currently storing in a block 133 of the victim reclaim unit 125 is needed for a period of time that is expected to extend beyond a time instance where the indicator 140 reaches the condition 145 for garbage collection 147, the garbage collection manager 113 in the host system 102 can be configured to read the data from the block 132 in the namespace 121 and overwrite 155 the block 132 with the retrieved data using a reclaim unit handle to cause the block 133 to be invalidated in the victim reclaim unit 125 (e.g., in a way similar to that illustrated in FIG. 5). The reclaim unit handle can be selected to group the retrieved data with other data having similar life for storing in another reclaim unit 127. Such an operation of overwrite 155 can increase write amplification for the data stored in the block 132 in the namespace 121 in a way similar to the copying 159 of residual valid data during garbage collection 147. However, since the host system 102 can arrange the data to be stored into another reclaim unit with other data having similar life, while the garbage collection manager 113 does not have such information about estimated life of data, such an operation of overwrite 155 by the host system 102 can be advantageous in reducing further write amplification associated with the data stored in the block 132 in the namespace 121.

Alternatively, such an overwrite 155 performed by the garbage collection manager 113 in the host system 102 can be skipped (e.g., to avoid the need to communicate the retrieved data to the host system 102 and back to the memory sub-system 101 for improved performance); and the residual valid data can be copied 159 by the garbage collection manager 113 in the memory sub-system 101 during the operation of garbage collection 147. In some implementations, the garbage collection manager 113 in the host system 102 can selectively skip such an overwrite 155 based on the current operating condition (e.g., whether there is a need to skip the read and write communications over a connection to the memory sub-system 103 to save communications bandwidth, to save power, etc.).

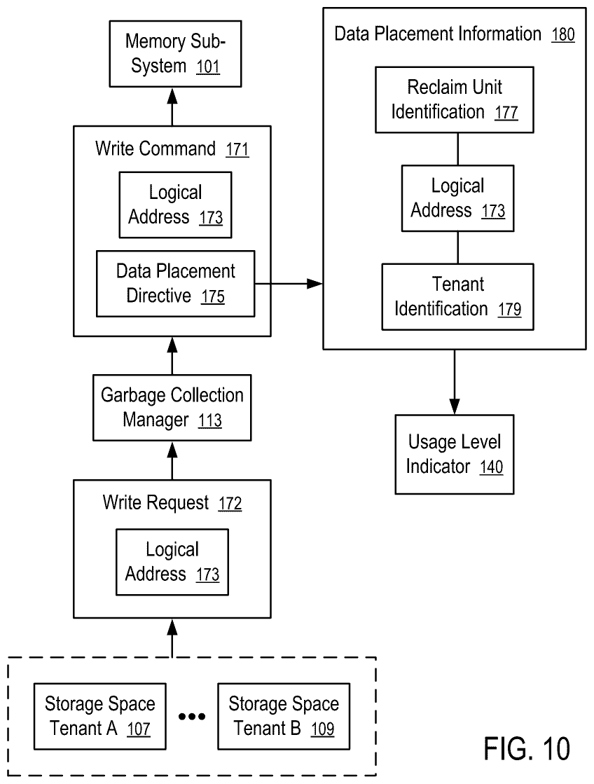

FIG. 10 shows a technique of tracking data placement information in a host system to facilitate operations of host folding according to one embodiment. For example, the operations of host folding 143 in FIG. 2 to FIG. 5 can be performed using the data placement information 180 in FIG. 10 with no communications outside of the storage access protocol for flexible direct placement according to one embodiment.

In FIG. 10, a garbage collection manager 113 running in a host system (e.g., 102 in a computing system 100 of FIG. 1) can be configured to send write commands (e.g., 171) to a memory sub-system 101 on behalf of storage space tenants 107, . . . , 109.

For example, when a storage tenant (e.g., 107 or 109) is to write a block of data to a logical address 173, the garbage collection manager 113 in the host system 102 can generate a write command 171 having a data placement directive 175 that causes the memory sub-system 101 to place the data of the write request 172 at a reclaim unit that stores data of similar life (e.g., for erasure at about the same time).

For example, the garbage collection manager 113 in the host system 102 can communicate with the storage space tenants 107, . . . , and 109 to determine an estimate time to the erasure of the data provided by the respective tenants 107, . . . , and 109. The garbage collection manager 113 can use a same reclaim unit handle to write data of similar time frame for erasure/expiration, which can cause the memory sub-system 101 to place the data on a same reclaim unit or a same group of reclaim units.

Alternatively, the garbage collection manager 113 can assign reclaim unit handles to the tenants 107, . . . , and 109 to allow the tenants 107, . . . , and 109 to generate write commands (e.g., 171) to the memory sub-system 101. Tenants 107, . . . , and 109 having similar data life cycles can be assigned to use a same reclaim unit handle.

In some implementations, the garbage collection manager 113 in the host system 102 can track historic data of life cycles of data of different types of tenants 107, . . . , 109 to group data onto reclaim units.

Based on the data placement directive (e.g., 175) used in the write commands (e.g., 171) sent to the memory sub-system 101, the garbage collection manager 113 in the host system 102 can track the data placement information 180.

For example, the data placement information 180 can track a set of logical addresses (e.g., 173) that have data written into a same reclaim unit (or a same group of reclaim units) represented by a reclaim unit identification 171. Further, the data placement information 180 can track which logical addresses (e.g., 173) are used by which tenant (e.g., represented by a tenant identification 179) so that the garbage collection manager 113 can contact the respective tenants during host folding 143.

Based on the data placement information 180, the garbage collection manager 113 in the host system 102 can compute an indicator 140 of usage level of reclaim units. For example, the garbage collection manager 113 can count the number of reclaim unit identifications 177 that is associated with at least one logical address 173 logical and use the count as the number of reclaim units that are not free in the memory sub-system 101. Alternatively, the garbage collection manager 113 can determine the indicator 140 in a way as discussed above in connection with FIG. 9.

When the usage level indicator 140 meets the condition 141 for host folding 143, the garbage collection manager 113 in the host system 102 can select a reclaim unit identification (e.g., 177) that has a set of logical addresses (e.g., 173) storing data that are about to expire. For example, the garbage collection manager 113 in the host system 102 can identify a set of reclaim unit identifications (e.g., 177) having data that is closest to expiration; and from such reclaim unit identifications (e.g., 177), the host system 102 can select, as victim reclaim units, one or more reclaim unit identifications that have the fewest associated logical addresses (e.g., 173) that store valid data. The garbage collection manager 113 can then communicate with the respective tenants, represented by the tenant identifications (e.g., 179) associated with the remaining logical addresses (e.g., 173) of the victim reclaim units to cause the respective tenants to deallocate 153 or erase data from the remaining logical addresses, or to overwrite 155 data to the remaining logical addresses (e.g., 173) of the victim reclaim units. Optionally, the garbage collection manager 113 can retrieve data from some of the remaining logical addresses (e.g., 173) and write the data back to respective logical addresses to cause the memory sub-system 101 to store the data to one or more other reclaim units.

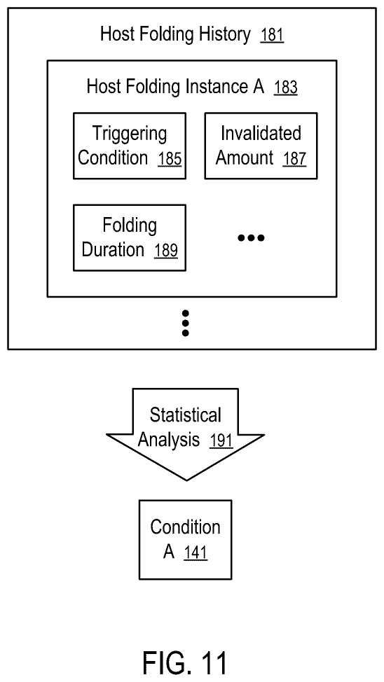

FIG. 11 shows a statistical analysis of history data of host folding to determine a condition to trigger host folding according to one embodiment. For example, the condition 141 to trigger host folding 143 in FIG. 2 to FIG. 5 can be established via the statistical analysis 191 in FIG. 11.

The garbage collection manager 113 in the host system 102 can be configured to collect data recording host folding history 181. When host folding 143 is triggered according to a triggering condition 185, the garbage collection manager 113 in the host system 102 can record data about the host folding instance 183. The recorded data for the instance 183 can include the triggering condition 185, the amount 187 of data that is stored in one or more victim reclaim unit and is invalidated during the instance of host folding 143, the duration 189 of the operations of host folding 143 in the instance 183, and other data, such as the time gap between completion of host folding 143 and the usage level indicator 140 reaching the condition 145 for garbage collection 147, etc.

After data about a plurality of host folding instances (e.g., 183) is recorded, a statistical analysis 191 can be performed (e.g., by the garbage collection manager 113 in the host system 102, or another computing device) to identify a condition 141 where the probability of host folding 189 completing before the indicator 140 reaching the condition 145 for garbage collection 147 is above a threshold.

Optionally, a cost function can be used to penalize the time gap between completion of host folding 143 and the usage level indicator 140 reaching the condition 145 for garbage collection 147. The cost function can further reward the invalidated amount (e.g., 187). The cost function can be minimized against the host folding history 181 to gradually reaching a statistically optimized condition 141 for the computing system 100.

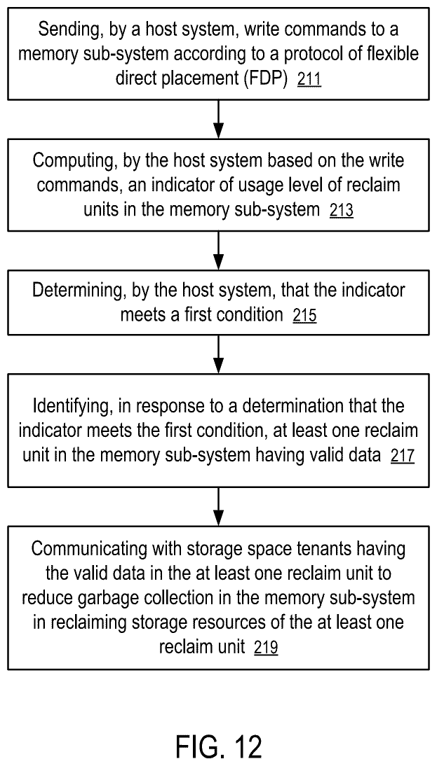

FIG. 12 shows a method to schedule operations of a host system to reduce garbage collection in a memory sub-system with minimal or no communications outside of storage access protocol for flexible direct placement according to one embodiment. The method of FIG. 12 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 12 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 12 can be implemented using the garbage collection managers 113 of FIG. 1 to perform the operations discussed in connection with FIG. 2 to FIG. 11.

For example, the method of FIG. 12 can be used in connection with the method of FIG. 8.

At block 211, the method of FIG. 12 includes sending, by a host system 102, write commands (e.g., 171) to a memory sub-system 101 according to a protocol of flexible direct placement (FDP). For example, the write commands (e.g., 171) can be sent in a way as discussed above in connection with FIG. 10.

At block 213, the method includes computing, by the host system based on the write commands, an indicator 140 of usage level of reclaim units 125, 127, . . . , 129 in the memory sub-system 101.

For example, the indicator can be representative of a ratio between a count of free reclaim units in the memory sub-system and a total count of reclaim units in the memory sub-system as discussed above in connection with FIG. 9.

For example, the garbage collection manager 113 running in the host system 102 can be programmed to decrease the count of free reclaim units by one for an amount of data being written into the memory sub-system 101 where the amount is equal to a storage capacity of one reclaim unit.

At block 215, the method includes determining, by the host system 102, that the indicator 140 meets a first condition 141.

At block 217, the method includes identifying, in response to a determination that the indicator 140 meets the first condition 141, at least one reclaim unit (e.g., 125) in the memory sub-system 101 having valid data.

For example, the identification of the at least one reclaim unit (e.g., 125) as victim reclaim units targeted for host folding 143 can be based on data placement information 180 tracked according to the data placement directive 175 in write commands (e.g., 171) sent from the host system 102 to the memory sub-system 101.

At block 219, the method includes communicating (e.g., by the garbage collection manager 113 running in the host system 102) with storage space tenants 107, . . . , 109 having the valid data in the at least one reclaim unit (e.g., 125) to reduce garbage collection 147 in the memory sub-system 101 in reclaiming storage resources of the at least one reclaim unit (e.g., 125).

For example, the communicating in block 219 can cause the storage space tenants 107, . . . , 109 to delete data from, overwrite data at, or deallocate the logical addresses that have valid data stored in the at least one reclaim unit (e.g., 125), as illustrated in FIG. 4 and FIG. 5.

For example, the garbage collection manager 113 running in the host system 102 can be programmed to increase the count of free reclaim units by a count of the at least one reclaim unit after the communicating to perform host folding 143.

For example, the garbage collection manager 113 running in the host system 102 can be programmed to: determine a life of data stored at a logical address and in the at least one reclaim unit (e.g., via communicating with the respective storage tenants/owners of the data); retrieve the data from the logical address (e.g., via sending read commands to the memory sub-system 101); select, based on the life, a reclaim unit handle of the memory sub-system (e.g., to group the data with other data having similar life); and write the data back to the logical address using the reclaim unit handle to cause the memory sub-system 101 to re-place the date of the logical address at a different reclaim unit that stores other data having life similar to the life determined for the data storage at the logical address.

The method of FIG. 12 can be performed without communications between the host system 102 and the memory sub-system 101 outside of the protocol of flexible direct placement. For example, it is not necessary to introduce a new command into an existing standard protocol for communications between host systems (e.g., 102) and memory sub-system 101 that supports flexible direct placement. For example, it is not necessary to introduce additional communications beyond what is the typical usages of the existing standard protocol, such as a standard for a nonvolatile memory express (NVMe) protocol.

For example, the memory sub-system 101 is configured, separately from the configuring of the host system 102, to be prevented (e.g., via a configuration of a firmware of the memory sub-system 101) from performing garbage collection before the indicator meets a second condition. For example, the first condition can be selected based on the second condition to allow the communicating to complete before the indicator changes to meet the second condition.

For example, the first condition is selected based on a statistical analysis 191 of historic data (e.g., history 181) recording operations of host folding 143 performed by the host system 101 in reducing valid data in reclaim units 125, 127, . . . , 129 in the memory sub-system 101.

Optionally, the garbage collection manager 113 running in the host system 102 can be programmed to store data grouping logical addresses (e.g., 173) having valid data stored in a reclaim unit (e.g., represented by a reclaim unit identification 177) and store data identifying identities (e.g., tenant identification 179) of storage space tenants (e.g., 107, . . . , 109) of the logical addresses (e.g., 173), as illustrated in FIG. 10.

In some implementations, the garbage collection manager 113 in the host system 102 is configured to communicate with the storage space tenants 107, . . . , 109 to determine an estimated time/duration needed by the storage space tenants 107, . . . , 109 to perform their operations in implementing host folding 143. Such operations of the storage space tenants 107, . . . , 109 are typically specific to the contexts and/or applications of the respective tenants 107, . . . , 109. When completed, the operations of the storage space tenants 107, . . . , 109 can result in the accelerated invalidation of their data stored in victim reclaim units (e.g., 125, 127, ...) targeted in host folding 143.

For example, the garbage collection manager 113 running in the host system 102 can use a predetermined interface and/or protocol to query the tenants 107, . . . , 109 about the estimated time/duration need for the operations to accelerate the invalidation of data in reclaim units (e.g., 125). The query can be performed at an initial phase of the host folding 143 for the selection of victim reclaim units (e.g., 125) and/or for the scheduling of sending, to storage space tenants 107, . . . , 109, folding requests that cause the respective tenants 107, . . . , 109 to accelerate invalidation of their valid data remaining in the victim reclaim units (e.g., 125).

When a storage space tenant (e.g., 107) receives a folding request from the garbage collection manager 113 to invalidate its data in a victim reclaim unit (e.g., 125), the storage space tenant (e.g., 107) can prioritize operations that, when completed, can cause the data in the victim reclaim unit (e.g., 125) to be invalidated.

The folding request can be configured to identify the victim reclaim unit (e.g., 125) and/or its data stored in the victim reclaim unit (e.g., 125) based on an identification 177 of the reclaim unit (e.g., 125), an identification of a reclaim unit handle that uses the reclaim unit (e.g., 125), a logical address (e.g., 173) having a storage space mapped to, and implemented using, the reclaim unit (e.g., 125) according to the address map 139, and/or the namespace (e.g., 121) in which the logical address (e.g., 173) is defined.

For example, the storage space tenant 107 can be configured to determine, in response to the folding request, whether the data in the victim reclaim unit (e.g., 125) is no longer needed. If the data is no longer needed, the storage space tenant 107 can explicitly identify to the garbage collection manager 113 that the data is no longer needed, send a command to deallocate the logical address (e.g., 173) or the namespace (e.g., 12), or send a command to delete the data from the logical addresses. If the storage space tenant 107 identifies to the garbage collection manager 113 in the host system 102 that the data is no longer needed, the garbage collection manager 113 can send a command to the memory sub-system 101 to cause the data in the victim reclaim unit (e.g., 125) to be marked as invalid.

Alternatively, or in combination, the storage space tenant 107 can be configured to perform, in response to the folding request, the computations to determine an updated version of data to be stored at the logical address 173 of the data to be invalidated in the victim reclaim unit 125. Upon completion of the computations, the storage space tenant 107 can send a write request 172 to store the updated version of data at the logical address 173. The write request 172 can cause the memory sub-system 101 to program the updated version of the data into an alternative reclaim unit (e.g., 129) allocated to implement the storage space of the logical address 173 and thus cause the data stored in the victim reclaim unit 125 to be marked as invalid. The memory sub-system 101 then updates the address map 139 to map the logical address 173 to the alternative reclaim unit (e.g., 129)

Alternatively, or in combination, the storage space tenant 107 can be configured to determine, in response to the folding request, whether the valid data currently stored in the victim reclaim unit (e.g., 125) is to be used in computations soon and if so, whether the data can be discarded after the computations. If the data can be discarded after the computations, the storage space tenant 107 can prefetch the data for storing a copy (e.g., in the host system 102 and outside of the memory sub-system 101) in anticipation of the computations. Once the data is prefetched, the data in the victim reclaim unit (e.g., 125) can be marked as invalid to accelerate the invalidation of the data in the victim reclaim unit (e.g., 125). Optionally, the storage space tenant 107 can further prioritize the use of the data to accelerate its expiration.

In general, a storage space tenant 107 can have multiple ways to accelerate the invalidation of its data in a victim reclaim unit (e.g., 125). Different ways to invalidate the data can require different amounts of time to complete. Thus, in response to a query for an estimated time/duration needed to invalidate the data in a victim reclaim unit (e.g., 125), the storage space tenant 107 can select, from the multiple ways, an optimized way that uses a smallest amount of time and/or at a smallest cost (e.g., cost in terms performance impact on other tasks, disturbance in computations, increase in memory usages) to invalidate the data. The storage space tenant 107 can provide, as a response to the query for time estimate, the amount of time to perform the invalidation in the optimized way when a folding request is received to target the victim reclaim unit (e.g., 125) for accelerated data invalidation. Optionally, the storage space tenant 107 can further provide the cost estimate for the accelerated data invalidation.

In some implementations, in the response to the query for estimated time/duration for performing operations responsive to a folding request to invalidate data in a victim reclaim unit (e.g., 125), the storage space tenant 107 can provide not only the requested time/duration estimate, but also an indicator of the cost for accelerating the invalidation of the data in the victim reclaim unit (e.g., 125). The time estimation and the cost indicator can be use by the garbage collection manager 113 to select a set of victim reclaim units (e.g., 125) and schedule sending of requests to invalidate the data in the selected victim reclaim units (e.g., 125), so that the host folding 143 targeting the selected victim reclaim units (e.g., 125) is complete at a time that is before and that is close to the onset of the garbage collection 147, with a least amount of cost for accelerating the invalidation.

In general, the storage space tenants (e.g., 107, . . . , and 109) are configured separately to provide, based on their data usage patterns and application specific information, estimates of time needed for completing the task of folding a particular set of data in a victim reclaim unit (e.g., 125). In response to folding requests, the storage space tenants (e.g., 107, . . . , and 109) can have different operations to perform so that, upon completion of the different operations, the data as stored in the victim reclaim unit (e.g., 125) is invalidated. Invalidating the data allows the erasure of the victim reclaim unit (e.g., 125) with no garbage collection 147, or with reduced garbage collection 147, in the memory sub-system 101.

For example, a storage space tenant 107 can have a portion of its data currently stored in a reclaim unit 125. When the reclaim unit 125 is identified a candidate for host folding 143, the storage space tenant 107 can estimate, based on its data usage activities, the time to complete folding/invalidating the data in the reclaim unit 125. The estimated time represents an estimate of the accelerated time frame for the expiration of the data residing in the reclaim unit 125. The acceleration is a response to a folding request from the garbage collection manager 113 running in the host system 102.

The time to complete responding to a folding request can be estimated as a period of time between when the tenant 107 receives the folding request and when the tenant 107 completes necessary operations that lead to the data to be invalided in the victim reclaim unit 125.

In response to a request to fold/invalidate the data in the victim reclaim unit 125, the tenant 107 can prioritize the usage of the data over other tasks. After the usage of the data, the tenant 107 can deallocate 153 the logical storage space used by the data (e.g., as in FIG. 4) or delete the data, or overwrite 155 the data with new data (e.g., as in FIG. 5).

Optionally, in response to a request to fold/invalidate the data, the tenant 107 can retrieve the data for caching in a random access memory in the host system 102 (e.g., in anticipation of use and disposal). Once the data is cached, the tenant 107 can thus deallocate 153 the logical addresses of the data or otherwise accelerate the invalidation of the data currently being valid in the reclaim unit 125. Since a copy of the data is cached in the random access memory of the host system 102, the invalidation of the data in the victim reclaim unit 125 can be done before the completion of the use of the data.

Optionally, in response to a request to fold/invalidate the data, the tenant 107 can determine that the data has a life longer than previously expected. In some instances, the tenant 107 can determine it is advantageous to relocate the data to an alternative reclaim unit that is used to store data having life matching with the remaining life of the data currently in the victim unit 125. Therefore, the tenant 107 can estimate the time to complete folding as the time needed to retrieve the data from the victim reclaim unit 125 and to write the retrieved data back to the target reclaim unit with other data having similar life.

In general, a reclaim unit (e.g., 125) can have data stored for a plurality of storage space tenants (e.g., 107, . . . , 109). Different storage space tenants (e.g., 107, . . . , 109) can require different amounts of time to complete their tasks of folding/invalidating their data in a same victim reclaim unit (e.g., 125), due to different levels of complexities in their usages of data. The garbage collection manager 113 in the host system 102 can be configured to communicate with the storage space tenants (e.g., 107, . . . , 109) to obtain their estimates of folding time for completing their responses to folding requests. The time estimates can be used by the garbage collection manager 113 running in the host system 102 to optimize the selection of victim reclaim units (e.g., 125) for host folding 143 and/or to optimize the timing of sending the folding requests to the storage space tenants (e.g., 107, . . . , 109) to implement accelerated folding/invalidating of their data in the victim reclaim units (e.g., 125).

For example, the garbage collection manager 113 running in the host system 102 can estimate a time duration available to perform host folding 143. For example, based on the pattern in the changes in the usage level indicator 140, the garbage collection manager 113 can estimate/predict a time duration before the usage level indicator 140 changes from its current level to reach the condition 145 for garbage collection 147.

Among a set of victim candidates, the garbage collection manager 113 can select, based on folding time estimates of the storage space tenants (e.g., 107, . . . , 109), one or more victim reclaim units (e.g., 125) that can have most folding tasks completed before the usage level indicator 140 reaches the condition 145, in order to maximize data invalidation before garbage collection 147. Targeting such victim reclaim units (e.g., 125) for host folding 143 can maximize the benefit of garbage collection reduction.

Further, the garbage collection manager 113 running in the host system 102 can throttle and/or schedule the sending of folding requests to the respective storage space tenants (e.g., 107, . . . , 109) of the selected victim reclaim units (e.g., 125). The folding requests can be scheduled such that the time gaps between the completions of responding to the folding requests by the storage space tenants (e.g., 107, . . . , 109) and the time instance of the usage level indicator 140 reaching the condition 145 of garbage collection 147 are reduced (or not longer than a threshold). Delaying the folding requests can provide opportunities for the invalidation to occur without the folding requests. If a piece of data is invalidated before the scheduled folding request for the data, the folding request can be skipped to minimize disturbances. Thus, the arrangement to schedule the dispatching of the folding tasks according to the time estimates provided by the storage space tenants (e.g., 107, . . . , 109) can reduce the impact of accelerating the folding/invalidation and reduce the cost and disturbances to the normal operations and schedules of the storage space tenants (e.g., 107, . . . , 109). With such a way to schedule folding requests to the storage space tenants (e.g., 107, . . . , 109), host folding 143 can complete just before and/or close to the starting of garbage collection 147 in the memory sub-system 101.

In some instances, a storage space tenant (e.g., 109) cannot provide an estimate of folding time for validating its data in a reclaim unit (e.g., 125). The garbage collection manager 113 running in the host system 102 can be configured to use a predictive model to estimate a folding time for the storage space tenant (e.g., 109).

For example, the garbage collection manager 113 can track the size of data written by the storage space tenant (e.g., 109) into a namespace (e.g., 121) in the memory sub-system 101. Based on the past activities of the data in a namespace (e.g., 121), the garbage collection manager 113 can estimate a time for the entire data of the tenant (e.g., 109), or a portion of it, to become expired. For example, the estimate can be based on an average rate of data expiration of the tenant 109 or tenants having similar data usage patterns. The predictions computed by the garbage collection manager 113 can be used in selecting victim reclaim units and/or scheduling the folding requests/operations without time estimates for the storage space tenant (e.g., 109).

In some instances, a storage space tenant (e.g., 109) does not support a communication protocol to accept folding requests. The garbage collection manager 113 running in the host system 102 can be configured to optionally perform folding operations on behalf of the storage space tenant (e.g., 109) to accelerate folding of data in a victim reclaim unit (e.g., 125).

For example, in some instances, the garbage collection manager 113 predicts that the data of the storage space tenant (e.g., 109) in the victim reclaim unit (e.g., 125) has a life significantly longer than the average life of other data in the victim reclaim unit (e.g., 125). In response, the garbage collection manager 113 can relocate the data of the storage space tenant (e.g., 109) without assistance from the storage space tenant (e.g., 109). For example, the relocation can be implemented by the garbage collection manager 113 retrieving the data from a logical address (e.g., 173) having its storage space implemented in the victim reclaim unit (e.g., 125) and writing the data back to the same logical address (e.g., 173) with a data placement directive 175 that is configured to cause the data to be written to another reclaim unit (e.g., 129) that stores data having life similar to the remaining life of the data being written back for relocation. In such a situation, the garbage collection manager 113 can estimate the time for retrieving the data and writing it back, without requesting the storage space tenant (e.g., 109) for a time estimate. For example, the garbage collection manager 113 can use the predictive model to estimate the remaining life of the data and perform the operations to invalidate the data in the victim reclaim unit (e.g., 125), without assistance from the storage space tenant (e.g., 109) that may, or may not, support communications for accepting folding requests and/or time estimates.

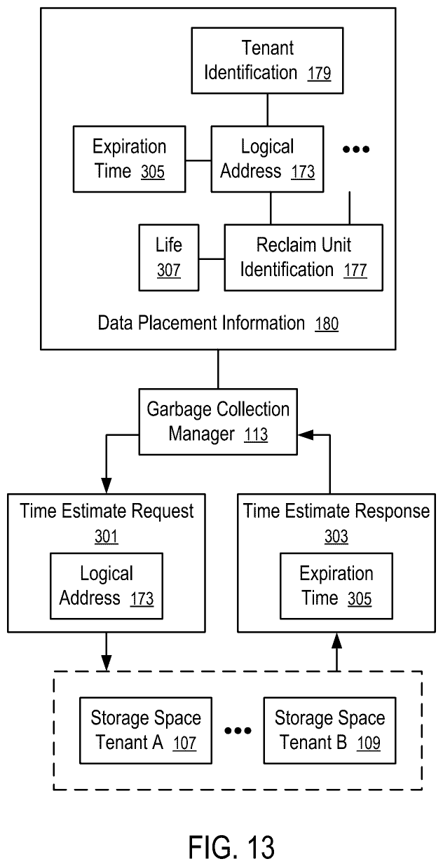

FIG. 13 shows a garbage collection manager in a host system configured to obtain time estimates from storage space tenants for host folding according to one embodiment. For example, the technique of FIG. 13 can be implemented in the host system 102 of FIG. 1 to support host folding 143 discussed above in connection with FIG. 2 to FIG. 12.

In FIG. 13, the garbage collection manager 113 running in the host system 102 is configured to track data placement information 180 based at least in part on data placement directives (e.g., 175) provided in write commands (e.g., 171) sent to the memory sub-system 101.

For example, when a storage space tenant 107 requests data to be written to the memory sub-system 101, the garbage collection manager 113 can cause the data to be written to a reclaim unit (e.g., 125) having an identification 177. The reclaim unit (e.g., 125) is selected to store data having life 307 similar to the life as estimated for the data to be written to the memory sub-system 101 for the storage space tenant 107. The garbage collection manager 113 can store data associating the reclaim unit identification 177 with a life 307 estimated for the entire set of data stored in the reclaim unit (e.g., 125) for one or more storage space tenants (e.g., 107, 109).

A data placement directive 175 is used in a write command 171 to write the data to the logical address 173 for the storage tenant 107 having an identification 179. Based on the data placement directive 175 for the write command 171, the garbage collection manager 113 can further store data associating the logical address 173 with the identification 177 of the reclaim unit 125 and data associating the logical address 173 with the identification 179 of the storage space tenant 107.

Data stored at the logical address 173 having a storage space implemented in the reclaim unit 127 represented by the identification 177 is invalidated through operations or commands, such as deallocation 153, deletion, overwrite 153, etc. When the data in the reclaim unit (e.g., 125) is invalidated, the garbage collection manager 113 can update the data placement information 180 to remove the association between the logical address 173 of the data and the reclaim unit identification 177.

Thus, based on the data placement information 180, the garbage collection manager 113 can determine which reclaim units (e.g., 125), represented by corresponding reclaim unit identifications (e.g., 177), are still in use to implement which logical addresses (e.g., 173) that have valid data.

The garbage collection manager 113 can select, based on the data placement information 180, a reclaim unit (e.g., 125 having identification 177) as a candidate for folding. For example, the reclaim unit (e.g., 125 having identification 177) can be a candidate when the life 307 associated with the reclaim unit identification 177 indicates that the entire set of data stored in the reclaim unit 125 is close to expiration. Alternatively, or in combination, the reclaim unit 125 can be a candidate when the data associating the logical addresses (e.g., 173) to the reclaim unit identification 177 indicates that there is a small portion of the storage capacity of the reclaim unit 125 remaining being used to implement the storage spaces of logical addresses (e.g., 173) having valid data in the reclaim unit 125.

Once the reclaim unit (e.g., 125) is identified as a candidate for host folding 143, the garbage collection manager 113 can further determine to what extent the data in the reclaim unit (e.g., 125) can be successfully invalidated before the onset of garbage collection 147 in the memory sub-system 101. The determination can be based on the garbage collection manager 113 communicating with the storage space tenants of the reclaim unit (e.g., 125) for estimates of accelerated expiration time 305 of the valid date remaining in the reclaim unit (e.g., 125).

For example, the garbage collection manager 113 can determine the identification 179 of the storage space tenant 107 associated with the logical address 173 in the data placement information 180. To determine the time needed for accelerated invalidation of the data at the logical address 173 having its storage space implemented in a reclaim unit 125 having the identification 177, the garbage collection manager 113 can send a time estimate request 301 to the storage space tenant 107. The time estimate request 301 includes the logical address 173 to allow the storage space tenant 107 to determine what is the shortest time to invalid the data at the logical address 173 as currently stored in the memory sub-system 101, if a folding request is sent to the storage space tenant 107.

In response, the storage space tenant (e.g., 107) can determine an estimated expiration time 305 in a time estimate response 303. For example, the estimate expiration time 305 can be configured to indicate that once a folding request targeting the logical address 173 is received in the storage space tenant (e.g., 107), the storage space tenant (e.g., 107) can complete its response to cause the expiration/invalidation of data at the logical address 173 as currently stored in the memory sub-system 101 (e.g., in the reclaim unit 125) after a period of time indicated by the estimated expiration time 305 relative to the time of the folding request.

The garbage collection manger 113 can store data associating the expiration time 305 with the logical address 173 to facilitate the selection of a victim reclaim unit in the operations of host folding 143.

In general, the reclaim unit 125 represented by the identification 177 can have different portions used to host the data of different logical addresses (e.g., 173) used by different storage space tenants (e.g., 107, 109). The garbage collection 113 can send respective requests (e.g., 173) to respective storage space tenants (e.g., 107, 109) to obtain their respective time estimate responses (e.g., 103).

Optionally, a time estimate response 303 can include not only the estimate of expiration time 305, but also an estimate of the cost to accelerate the data invalidation.

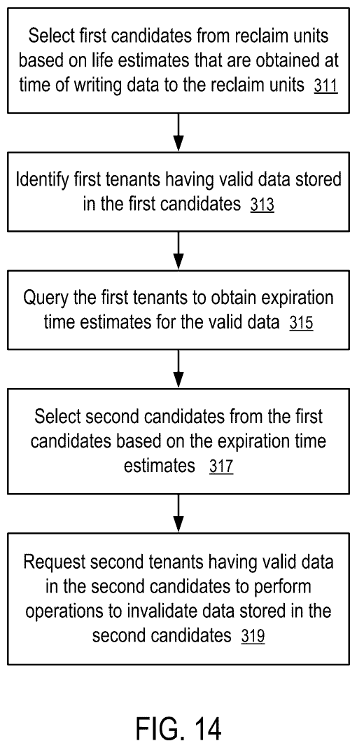

Thus, the data placement information 180 can be updated, via the time estimate requests (e.g., 301) and responses (e.g., 303), to show the expiration time (e.g., 305) (and the optional cost estimate) for a portion of data remaining valid in a folding candidate (e.g., the reclaim unit 125 represented by the identification 177). The garbage collection manager 113 can selectively target one or more victim reclaim units (e.g., 125) for sending folding requests to increase or maximize the benefit of garbage collection reduction and to reduce or minimize the cost of host folding 143, as further discussed in connection with FIG. 14 to FIG. 16.

FIG. 14 shows a technique to select victim reclaim units based on time estimates from storage space tenants according to one embodiment. For example, the technique of FIG. 14 can be implemented in the host system 102 of FIG. 1 to support host folding 143 discussed above in connection with FIG. 2 to FIG. 12 using the data placement information 180 of FIG. 13.

At block 311 of FIG. 14, a garbage collection manager 113 in a host system 102 selects first candidates from reclaim units (e.g., 125, 127, ...) based on life estimates (e.g., life 307) that are obtained at time of writing data to the reclaim units (e.g., 125, 127, ...).

For example, the first candidates can be selected according to the life estimates (e.g., life 307) such that data stored in the first candidates is expected to expire (and thus invalidated in the first candidates) within a predetermined time window from the time of the usage level indicator 140 reaching the condition 141 for host folding 143.

For example, the predetermined time window can be configured to extend to a time when the usage level indicator 140 is estimated or predicted to reach the condition 145 for garbage collection 147, or a threshold time interval after (or before) the time when the usage level indicator 140 is estimated or predicted to reach the condition 145 for garbage collection 147. The selection of the first candidates based on the life (e.g., 307) can exclude the operations to query some storage space tenants for data that is not likely to be invalidated before the garbage collection 147 starts in the memory sub-system 101.

Optionally, the garbage collection manager 113 can group storage space tenants 107, . . . , 109 that have data of similar life and assign a reclaim unit handle to the group for writing data to the memory sub-system 103. As a result, reclaim units (e.g., 125) used by the reclaim unit handle can have a same estimate of life 307 for data stored in the reclaim units (e.g., 125).

Optionally, when a storage space tenant (e.g., 107) sends a write request (e.g., 172) to the garbage collection manager 113 in the host system 102, the request 172 includes an estimated life (e.g., 307) for the data to be written for the write request (e.g., 172); and the garbage collection manager 113 can select a reclaim unit handle according to the estimated life (e.g., 307) for sending the write command 171.

At block 313, the garbage collection manager 113 identifies (e.g., based on data associating reclaim unit identifications (e.g., 177) and tenant identifications (e.g., 179)) first tenants (e.g., 107) having valid data stored in the first candidates (e.g., reclaim unit 125).

At block 315, the garbage collection manager 113 queries the first tenants (e.g., 107) to obtain expiration time estimates (e.g., expiration time 305) for the valid data.

At block 317, the garbage collection manager 113 selects second candidates from the first candidates based on the expiration time estimates.

For example, the garbage collection manager 113 can be configured to select no more than a predetermined number of reclaim units (e.g., 125) as victim reclaim units to have their data invalidated during host folding 143. The victim reclaim units can be selected such that if the folding requests are sent to target the victim reclaim units, the amount of valid data remaining in the victim reclaim units is zero, or is minimized, by the time the usage level indicator 140 reaches the condition 145 for garbage collection.

Optionally, when the storage space tenants further provide cost estimation with their expiration time estimates, the second candidates can be selected as victim reclaim units in a way that further minimizes the cost of accelerating the data expiration (e.g., accelerated via sending folding requests to the respective storage space tenants of the victim reclaim units).

At block 319, the garbage collection manager 113 requests second tenants having valid data in the second candidates to perform operations to invalidate data stored in the second candidates.

For example, the garbage collection manager 113 can postpone the sending of folding requests to the second tenants according to their expiration time estimates such that the completion of invalidating the data in the victim reclaim units occurs shortly before the onset of garbage collection 147 in the memory sub-system 101. If invalidation occurs before the scheduled folding requests, the corresponding folding requests can be skipped. Such an arrangement provides opportunities for invalidation to occur without acceleration (e.g., made via folding requests), which can minimize the impact and/or cost associated with host folding 143 performed before the garbage collection 147.

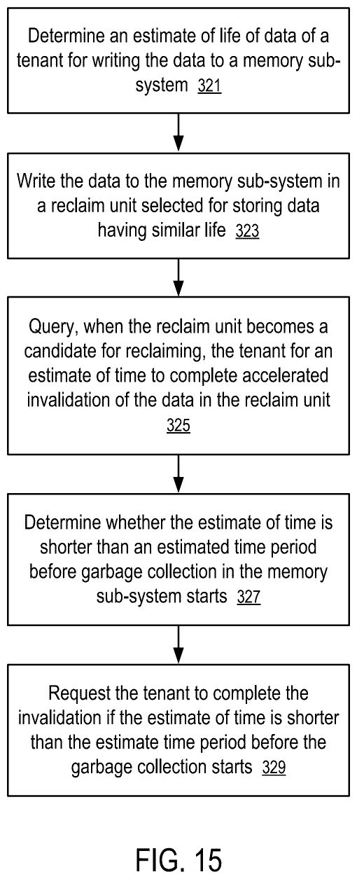

FIG. 15 shows a technique to perform host folding using time estimates from storage space tenants according to one embodiment. For example, the technique of FIG. 15 can be implemented in the computing system 101 of FIG. 1 to implement host folding 143 discussed above in connection with FIG. 2 to FIG. 12 using the data placement information 180 of FIG. 13.

At block 321, the host system 102 determines an estimate of life 307 of data of a storage space tenant (e.g., 107) for writing the data to a memory sub-system 101.

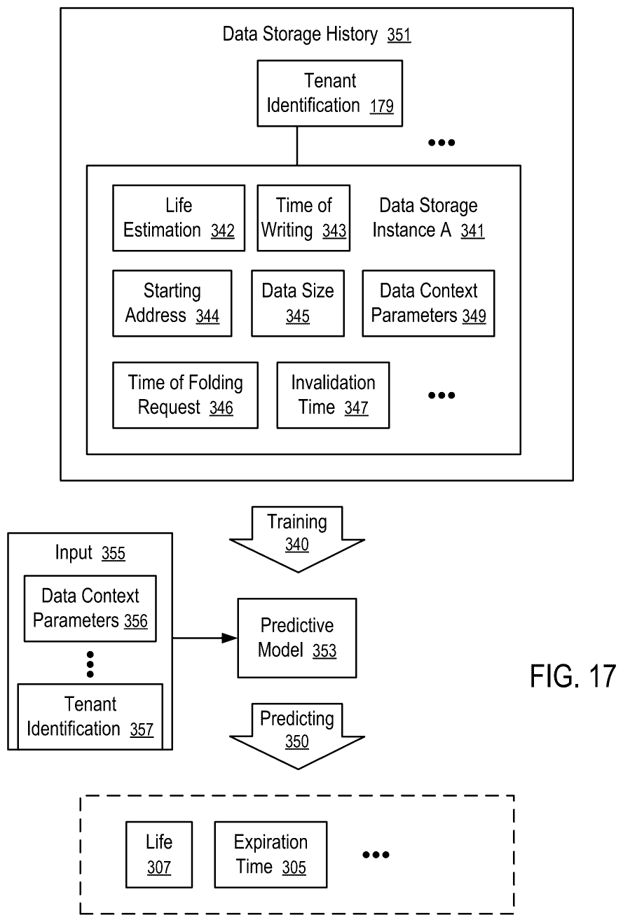

In some implementations, the storage space tenant (e.g., 107) provides the estimate of life 307 with the write request 172. In other implementations, the garbage collection manager 113 in the host system 102 uses a predictive model to estimate the life 307 (e.g., as in FIG. 17).

At block 323, the host system 102 writes the data to the memory sub-system 101 in a reclaim unit (e.g., 125) selected for storing data having similar life (similar to the estimate of life 307 of the data of the storage tenant (e.g., 107)).

At block 325, a garbage collection manager 113 in the host system 102 queries, when the reclaim unit (e.g., 125) becomes a candidate for reclaiming, the storage space tenant (e.g., 107) for an estimate of time (e.g., expiration time 305) to complete accelerated invalidation of the data in the reclaim unit (e.g., 125). For example, the query can be performed in a way as illustrated in FIG. 13 using a predetermined protocol (e.g., an application programming interface (API)).

For example, when the data is expected to expire, according to the estimate of life 307, within a predetermined time window, the reclaim unit (e.g., 125) can be identified as a candidate for reclaiming.

For example, after the reclaim unit (e.g., 125) is full, data in the reclaim unit (e.g., 125) can become invalidated during normal operations of the storage space tenants (e.g., 107, 109). When the amount of valid data remaining in the reclaim unit (e.g., 125) is lower than a threshold, the reclaim unit (e.g., 125) can be identified as a candidate for reclaiming.

At block 327, the garbage collection manager 113 determines whether the estimate of time (e.g., expiration time 305) is shorter than an estimated time period before garbage collection 147 in the memory sub-system starts.

For example, when garbage collection 147 in the memory sub-system starts can be estimated based on a prediction of when the usage level indicator 140 reaches the condition 145.

At block 329, the garbage collection manager 113 requests the storage space tenant (e.g., 107) to complete the invalidation if the estimate of time (e.g., expiration time 305) is shorter than the estimate time period before the garbage collection 147.

In some instances, the estimate of time (e.g., expiration time 305) can indicate that the remaining life of the data of the storage space tenant (e.g., 107) of the reclaim unit (e.g., 125) is significantly longer than the initial estimate of life (e.g., 307). In response, the garbage collection manager 113 can determine (e.g., in some instances) that it is advantages to relocate the data to another reclaim unit (e.g., 127) with other data having life substantially equal to the remaining life the data currently in the reclaim unit 125.

For example, in some instances, the garbage collection manager 113 in the host system 102 can determine that there are not enough victim reclaim units that can be completed evaluated for erasure before garbage collection 147; and when the garbage collection 147 starts, the reclaim unit (e.g., 125) is likely to be the target for garbage collection 147 in the memory sub-system 101. The memory sub-system 101 does not have information (or has less information than the host system 102) to support an optimized decision as to where to best relocated the data (e.g., for future reducing of write amplification). In such a situation, the garbage collection manager 113 in the host system 102 can decide to relocate the data for the storage space client (e.g., 107). For example, the garbage collection manager 113 can send a command to the memory sub-system 101 to retrieve the data from the logical address (e.g., 173) and then send another command to write the retrieved data back into the logical address (e.g., 173) using a data placement directive 175 configured to cause the data to be placed in a reclaim unit (e.g., 129) with other data having similar life. The garbage collection manager 113 can cause the data relocation between reclaim units without changing the logical address of the data and without sending a folding request to the storage space client (e.g., 107).

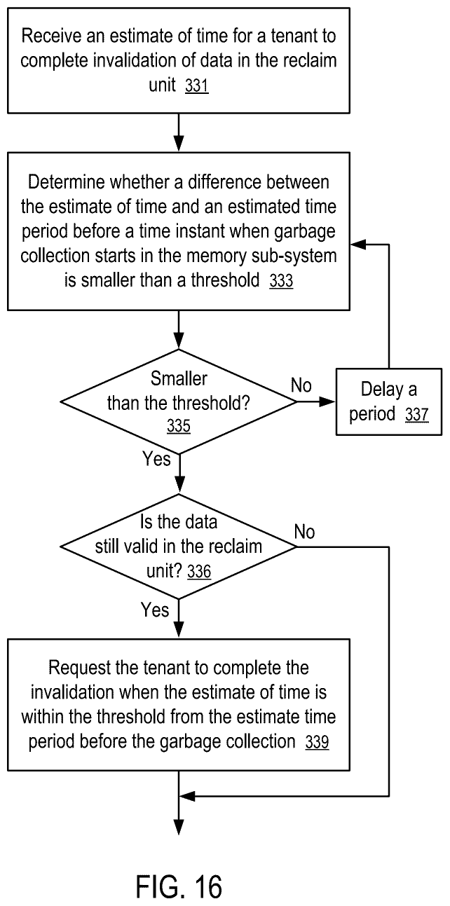

Optionally, the garbage collection manager 113 can delay sending the folding requests (e.g., as in FIG. 16) to storage space tenants (e.g., requests as in blocks 319 and 329) based on the expiration time estimates (e.g., expiration time 305 provided by tenants in time estimate response 303), as in FIG. 16.

FIG. 16 shows a technique to schedule sending requests to storage space tenants to invalidate data in a reclaim unit according to one embodiment. For example, the technique of FIG. 16 can be implemented in the computing system 101 of FIG. 1 during host folding 143 discussed above in connection with FIG. 2 to FIG. 12 using the data placement information 180 of FIG. 13.

At block 331, a garbage collection manager 113 in a host system 102 receives an estimate of time (e.g., expiration time 305) for a storage space tenant (e.g., 107) to complete invalidation of data in the reclaim unit (e.g., 125).

At block 333, the garbage collection manager 113 determines whether a difference between the estimate of time and an estimated time period before a predicted time instant when garbage collection 147 starts in the memory sub-system 101 is smaller than a threshold.

If it is determined, at block 335, the difference is not smaller than the threshold, the garbage collection manager 113 delays, at block 337, a period until the difference is smaller than the threshold.

At block 336, after the different is smaller than the threshold, the garbage collection manager 113 determines whether the data is still valid in the reclaim unit. If so, at block 339, the garbage collection manager 113 requests the storage space tenant (e.g., 107) to complete the invalidation; otherwise, the folding request scheduled to be sent in block 339 can be skipped.

As a result, if a folding request is needed and sent at block 336, the completion of the response by the storage space tenant (e.g., 107) to the folding request can occur within a threshold period from the onset of the garbage collection 147 in the memory sub-system 101. If the data is invalidated during the normal operation of the storage space tenant (e.g., 107) during the delay period, the folding request and its associated cost can be avoided.

In some implementations, the period for delaying the folding request is a fraction of the difference between the estimated time and the estimated time period to the onset of garbage collection 147. After the delay period, the estimated time period leading to the onset of garbage collection 147 can be updated to determine whether to further delay. In other implementations, the delay period is configured based on subtracting the threshold (or a fraction of threshold) from the difference.

In some instances, a storage space tenant may not be able to provide an estimate of expiration time, or does not have an interface to receive time estimate requests (e.g., 301) and to provide time estimate response (e.g., 303). Alternatively, or in combination, the storage space tenant does not, or cannot, provide an estimate of life 307 of its data to be written into the memory sub-system 101. The garbage collection manager 113 can use a predictive model to determine an estimate without assistance from the storage space tenant, as illustrated in FIG. 17.

FIG. 17 shows a technique to use a predictive model to determine life of data and time to invalidate the data according to one embodiment. For example, the technique of FIG. 16 can be implemented in the computing system 101 of FIG. 1 during host folding 143 discussed above in connection with FIG. 2 to FIG. 12 using the data placement information 180 of FIG. 13. The technique of FIG. 17 can be used for some storage space tenants, while the technique of FIG. 13 is used for other storage space tenants, in connection with the use of methods of FIG. 14 to FIG. 16.

In FIG. 17, the garbage collection manager 113 in a host system 102 is configured to track data representative of data storage history 351. For a data storage instance (e.g., 341) of writing data of a size 345 to a contiguous region in a namespace (e.g., 121) at a starting address 344, the garbage collection manager 113 can track the identification 179 of the storage space tenant (e.g., 107) that requests the writing of the data.

For the data storage instance 341, the garbage collection manager 113 records the time 343 of the writing request/operation, and the life estimation 342 (e.g., provided by the storage space tenant (e.g., 107), or by the predictive model 353). When available, the garbage collection manager 113 can further record parameters 349 that are indicative of the context of the data being stored.

Optionally, the data as written to a reclaim unit (e.g., 125) can be invalidated via a folding request (e.g., as sent at blocks 319, 329, and 339 in FIG. 14 to FIG. 16). Alternatively, the data can be invalidated by the storage space tenant (e.g., 107) during its normal operations without a folding request. The garbage collection manager 113 can detect and record the invalidation time 347, which can be combined with the time 343 of writing to compute the actual life span of the data for the data storage instance 341 in the reclaim unit (e.g., 125).

When the data is invalidated via a folding request, the actual time period used by the data storage instance 341 to complete the accelerated invalidation can be determine from the time 346 of the folding request and the time 347 when the data is invalidated.

Based on a collection of records about data storage instances (e.g., 341) stored in the history 351 for various storage space tenants (e.g., 107, 109), a predictive model 353 can be trained (e.g., 340) to minimize the differences between predictions generated from the predictive model 353 and the actual time/life measurements captured in the history 351.

Some of the data fields in the history 351 for a data storage instance 134 can be specified as an input 355 to the predictive model 353 to generate a predicted life 307 and/or a predicted expiration time 305. For example, data fields used in the input 355 can include data context parameters 356, tenant identification 357, and other data fields, such as time 343 of writing, data size 345, starting address 344, etc.

In general, there is a difference between the life 307 predicted by the predictive model 353 and the corresponding actual life as measured in the data storage instance 341. A plurality of data storage instances (e.g., 341) can be used as a training dataset so that the parameters in the predict model 353 are adjusted during training 340 to minimize the overall differences between the prediction results and corresponding measurements in the training dataset.

After the training 340, the predictive model 353 can be used in mode of predicting 350 to generate predictions of life 307 and expiration time 305 without assistance from the storage space tenants (e.g., 107, 109).

For example, when a storage space tenant (e.g., 109) cannot provide an estimate of the life 307 or expiration time 305, the garbage collection manager 113 in the host system 102 can use the predictive model 353 to obtain a corresponding estimate in the operations of host folding 143 (e.g., as operations in FIG. 14 to FIG. 16).

For example, when a storage space tenant (e.g., 109) does not support the communications to provide an estimate of expiration time (e.g., 305), the predicted expiration time (e.g., 305) generated from the predictive model 353 can be used as a substitute for the estimates involved in operations discussed above in connection with FIG. 14 to FIG. 16.

In some instances, the predictive model 353 can provide an indication of the confidence level of a prediction (e.g., expiration time 305); and when the confidence level is above a threshold, the garbage collection manager 113 can optionally skip the communications (e.g., request 301 and response 303) with the storage space tenant (e.g., 107) to obtain the estimates, even when the storage space tenant (e.g., 107) can provide such an estimate.

In some implementations, the predictive model 353 is configured based on a technique of artificial neural network. In other implementations, the predictive model 353 is configured on a decision tree, or an empirical formula.

In some implementations, a storage space tenant (e.g., 107) is configured with a garbage collection manager 113 to track the history 351 of instances (e.g., 341) stored by the storage space tenant (e.g., 107) to the memory sub-system 101. The garbage collection manager 113 of the storage space tenant (e.g., 107) can train 340 its private model 353 for the predictions of life (e.g., 307) of its data, and predictions of expiration time (e.g., 305). In response to a time estimate request 301, the storage space tenant (e.g., 107) can use its predictive model 353 to determine the expiration time 305 for a time estimate response 303. Further, when the storage space tenant (e.g., 107) sends a write request 172 to write data to a logical address 173, the storage space tenant (e.g., 107) can use its predictive model 353 to predict the life (e.g., 307) of the data to be written into the logical address 173 to facilitate the grouping of data of similar life into a same reclaiming unit.

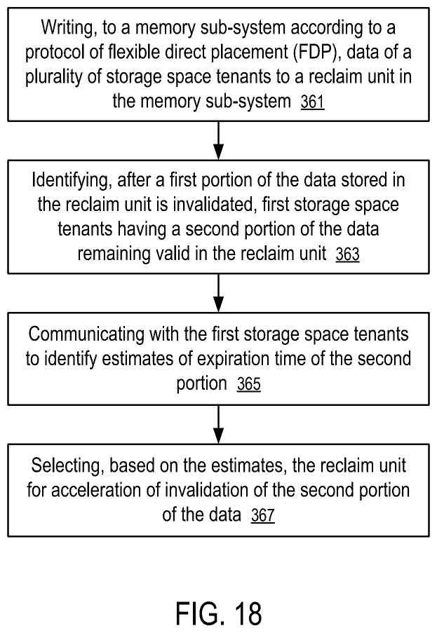

FIG. 18 shows a method to perform host folding based on time estimates of storage space tenants according to one embodiment. The method of FIG. 18 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 18 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 18 can be implemented using the garbage collection managers 113 of FIG. 1 to perform the operations discussed in connection with FIG. 2 to FIG. 16.

At block 361, the method of FIG. 18 includes writing, to a memory sub-system 101 according to a protocol of flexible direct placement (FDP), data of a plurality of storage space tenants 107, . . . , 109 to a reclaim unit 125 in the memory sub-system 101.

At block 363, the method includes identifying, after a first portion of the data stored in the reclaim unit is invalidated, first storage space tenants (e.g., 107) having a second portion of the data remaining valid in the reclaim unit 125.

For example, after the usage level indicator 140 reaches the condition 141 for host folding 143, the garbage collection manager 113 can start operations to identify candidates for victim reclaim units. When the reclaim unit 125 has date with a life 307 that is about to reach expiration near or before an estimated onset of garbage collection 147 (e.g., when the usage level indicator 140 reaches condition 145), the reclaim unit 125 can be selected as a candidate for reclaiming. To reclaim the reclaim unit 125, the first storage space tenants (e.g., 107) can be requested to perform operations to accelerate the invalidation of the second portion of the data before the usage level indicator 140 reaches the condition 145 for garbage collection 147.

In some instances, the reclaim unit 125 is selected for reclaiming based at least in part that the ratio between the size of the second portion of the data remaining valid in the reclaim unit 125 and the storage capacity of the reclaim unit 125 is below a threshold.

At block 365, the method includes communicating, by the garbage collection manager 113, with the first storage space tenants (e.g., 107) to identify estimates of expiration time 305 of the second portion.

For example, time estimate requests (e.g., 301) and responses (e.g., 303) can be communicated between the garbage collection manager 113 in the host system and the first storage space tenants (e.g., 107), as in FIG. 13.

At block 367, the method includes selecting, based on the estimates, the reclaim unit 125 for acceleration of invalidation of the second portion of the data.

For example, the method of FIG. 18 can further include: estimating a time period to onset of garbage collection 147 in the memory sub-system 101. The selection of reclaim unit 125 for invalidation acceleration can be based at least in part on the estimates being indicative that when requested, the first storage space tenants (e.g., 107) are able to complete the invalidation before an end of the time period (and thus before the onset of garbage collection 147 in the memory sub-system 101).

Optionally, the selection can be further based on the minimization of cost associated with the acceleration. For example, the first storage space tenants (e.g., 107) can provide, together with the estimates, identifications of cost for completing the accelerated invalidation when requested.

For example, the method of FIG. 18 can further include: sending a request to a second storage space tenant (e.g., 107), among the first storage space tenants, a request to accelerate invalidation of a third portion of the data, the third portion written by the second storage space tenant (e.g., 107) to the memory sub-system 101. The third portion of the data can be identified based on a logical address (e.g., 173) used to write the third portion of the data to the memory sub-system 101 when the write request 172 is submitted.

For example, the method of FIG. 18 can further include: scheduling the sending of the request to accelerate invalidation of the third portion of the data based on an estimate of expiration time 305, among the estimates, received in a time estimate response 303 from the second storage space tenant (e.g., 107). As illustrated in FIG. 16, the scheduling can be based on delaying the request for accelerated invalidation according to a difference between the estimate of expiration time 305 and the time period leading to the onset of garbage collection 147.

For example, the estimate of expiration time can be configured to identify a time duration between reception of the request for accelerated invalidation and completion of invalidation the third portion of the data. For example, the completion of invalidation of the third portion can be based on a command to reallocate the logical address 173, a command to write data to the logical address 173, or a command to delete data from the logical address 173.

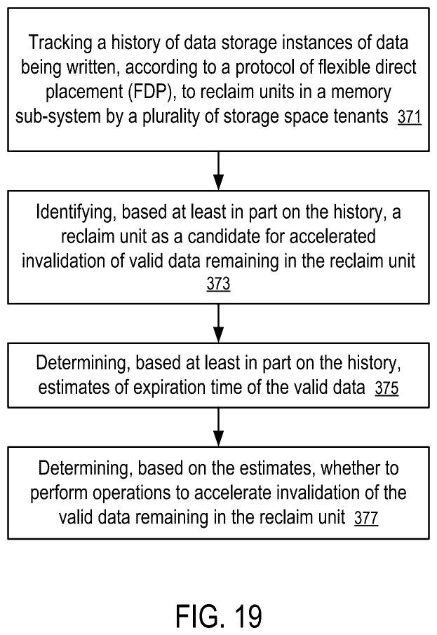

FIG. 19 shows a method to perform host folding based on time estimates from a predictive model according to one embodiment. The method of FIG. 19 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 19 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 19 can be implemented using the garbage collection managers 113 of FIG. 1 to perform the operations discussed in connection with FIG. 2 to FIG. 18.

At block 371, the method of FIG. 19 includes tracking a history 351 of data storage instances (e.g., 341) of data being written, according to a protocol of flexible direct placement (FDP), to reclaim units (e.g., 125, 127) in a memory sub-system 101 by a plurality of storage space tenants 107, . . . , 109.

At block 373, the method includes identifying, based at least in part on the history, a reclaim unit (e.g., 125) as a candidate for accelerated invalidation of valid data remaining in the reclaim unit (e.g., 125).

For example, when the user level indicator 140 reaches a condition 141 for host folding 143, the garbage collection manager 113 running in the host system 102 can start to identify candidates of victim reclaim units. Invalidation of data in the victim reclaim units can be accelerated during host folding 143 such that when the usage level indicator 140 reaches the condition 145 for garbage collection 147, valid data remaining in the victim reclaim units is minimized. Minimizing the remaining valid data can reduce or eliminate the operations of garbage collection 147 in the memory sub-system 101 (e.g., copying valid data to other reclaim units for the erasure of the victim reclaim units).

At block 375, the method includes determining, based at least in part on the history 351, estimates of expiration time (e.g., 305) of the valid data remaining in the reclaim unit (e.g., 125).

For example, when some of the storage space tenants having valid data in the reclaim unit (e.g., 125) support a protocol/interface for time estimate request 301 and time estimate response 303, the garbage collection manager 113 running in the host system 102 can use the interface to obtain the estimates of expiration time 305 using the protocol/interface.

For example, when a storage space tenant (e.g., 107) does not support the protocol/interface and/or fails to provide an estimate for some reasons, the garbage collection manager 113 running in the host system 102 can use a predictive model 353 trained using at least a portion of the history 351 to generate the estimate for the storage space tenant (e.g., 107). Thus, the determining of the estimates performed in block 375 can include obtaining the estimates from the predictive model 353 trained using a portion of the history 351.

For example, the portion of the history 351 can record, for a plurality of data storage instances (e.g., 351), data indicative of actual life of first data stored in the plurality of data storage instances (e.g., 341). For example, the first data can have a data size 345 and be written to the address 344 at the time 343. For example, the combination of the time 343 of writing and the time 347 of invalidation can provide the actual life of the data stored in the instance 341.

Further, the portion of the history 351 can further record, for the plurality of data storage instances (e.g., 351), data indicative of actual expiration time of the first data resulting from prior operations to accelerate invalidation of the first data. For example, the combination of the time 346 of folding request and the time 347 of invalidation can provide the actual expiration time that results from the folding request 346.

Optionally, the garbage collection manager 113 running in the host system 102 (or another computer, such as a server computer) can periodically train the predictive model using the portion of the history 351 to improve and/or update the prediction capability of the model 353.

At block 377, the method includes determining, based on the estimates, whether to perform operations to accelerate invalidation of the valid data remaining in the reclaim unit (e.g., 125).

For example, the garbage collection manager 113 running in the host system 102 can estimate a time period leading to onset of garbage collection 147 in the memory sub-system 101 (e.g., based on monitoring the progress of changes in the usage level indicator 140). The time period can be used in determining whether to perform operations to accelerate invalidation of the valid data remaining in the reclaim unit.

For example, when the estimates as determined in block 375 are indicative that the first storage space tenants are able to complete accelerated invalidation of the valid date before the end of the time period, the reclaim unit (e.g., 125) can be selected as a victim reclaim unit for invalidation acceleration. To accelerate the invalidation, the garbage collection manager 113 in the host system can send a folding request to a second storage space tenant (e.g., 107), among the first storage space tenants, to accelerate invalidation of a portion of the valid data previously written by the second storage space tenant (e.g., 107) to the memory sub-system.

Optionally, the method can further include determining a remaining life of a portion of the valid data; and accelerating invalidation of the portion of the valid data in the reclaim unit (e.g., 125) via: retrieving, from the memory sub-system 101 and according to a logical address 173 of the portion of the valid data, the portion of the valid data; and writing, back to the memory sub-system 101 according to the logical address, the portion of the valid data with a data placement directive (e.g., 175) configured based on the remaining life to cause the portion of the valid data to be invalidated in the reclaim unit (e.g., 125) and to be stored in another reclaim unit (e.g., 129). For example, the data placement directive (e.g., 175) can be configured to selectively group data of similar life for storing in the reclaim unit (e.g., 129) such that the data in the reclaim unit (e.g., 129) will be subsequently invalidated in the reclaim unit (e.g., 129) at about a same time to reduce garbage collection 113 for the erasure of the reclaim unit (e.g., 129).

For example, the remaining life can be predicted using the predictive model 353 (or provided by a storage space tenant (e.g., 107) in a time estimate response 303). When the remaining life is longer than a threshold, the garbage collection manager 113 in the host system 102 can determine, in some instances, that it is advantageous to relocate the portion of the valid data (instead of leaving it for the memory sub-system 101 to relocate the data during garbage collection 147). Thus, the garbage collection manager 113 can issue the read and write back operations to accelerate the invalidation of the portion of the valid data.

For example, the portion of the valid data is previously written by a second storage space tenant (e.g., 107), among the first storage space tenants, to the reclaim unit (e.g.,, 125); and the accelerating can be performed by the garbage collection manager 113 without assistance from the second storage space tenant (e.g., 107) and without sending a folding request to the second storage space tenant (e.g., 107).

In some situations, it can be advantages for the host system 102 to identify a reclaim unit (e.g., 125) for erasure by the memory sub-system 101. The host system 102 can have more information than the memory sub-system 101 in selecting victim reclaim units for erasure. Erasing victim reclaim units identified by the host system 102 can have better performance in write amplification reduction than erasing victim reclaim units identified by the memory sub-system 101.

For example, consider a situation where there is less valid data remaining in reclaim unit B 127 than in reclaim unit A 125. Without further information, the memory sub-system 101 is to select reclaim unit B 127 over reclaim unit A 125 for erasure.

During garbage collection 147, selecting the reclaim unit B 127 as a victim reclaim unit for erasure involves copying remaining valid data from reclaim unit B 127 to another reclaim unit (e.g., 129); and selecting the reclaim unit A 125 as a victim reclaim unit for erasure involves copying remaining valid data from reclaim unit A 125 to another reclaim unit (e.g., 129). Since the reclaim unit B 127 has less valid data remaining that the reclaim unit A 125, erasing the reclaim unit B 127 appears to involve copying less data than erasing the reclaim unit A 125.

However, the host system 102 can have more information to better prioritize the erasure of reclaim units.

For example, in some cases, some or all of the remaining valid data in the reclaim unit B 127 will be invalidated by the storage space tenants (e.g., 107) in a short period of time after garbage collection 147 is triggered in the memory sub-system 101. In contrast, the amount of valid data remaining in the reclaim unit A 125 can be the same after the period of time. In such a situation, it can be advantageous to delay garbage collection 147 on the reclaim unit B 127 and start garbage collection 147 with the reclaim unit A 125.

For example, through communications with storage space tenants 107, . . . , 109 (e.g., time estimate requests 301 and time estimate responses 303 as in FIG. 13), the host system 102 can determine, predict, or estimate the amounts of remaining valid data in different reclaim units (e.g., 125, 127) in a time period after the usage level indicator 140 reaches the condition 147. In some instances, the storage space tenants 107, . . . , 109 can continue their operations to invalidate data in the reclaim units (e.g., 125, 127) during the time period. Prioritizing the erasure of the reclaim units (e.g., 125, 127) according to the amounts of valid data remaining there after the period of time can maximize the benefit of write amplification reduction. However, such information is generally not available to the memory sub-system 101.

For example, the garbage collection manager 113 in the host system 102 can send folding requests (e.g., as at blocks 319, 329, 339 in FIG. 14 to FIG. 16) to the storage space tenants (e.g., 107) to invalidate data in the reclaim unit B 127. In some instances, the storage space tenants (e.g., 107) fail to complete the folding operations to invalidate the data as requested before the usage level indicator 140 reaches the condition 145 for garbage collection 147. Without requesting the storage space tenants (e.g., 107) to abort the folding operations performed to invalidate data according to the folding requests, the garbage collection manager 113 in the host system 102 can determine that the folding operations will complete soon and thus invalid the remaining valid data in the reclaim unit B 127. Therefore, it can be advantageous to delay the garbage collection 147 performed on the reclaim unit B 127 and prioritize the garbage collection 147 performed on another victim reclaim unit (e.g., 125).

For example, the garbage collection manager 113 in the host system 102 can use a predictive model (e.g., 353 in FIG. 17) to determine that the invalidation of the remaining data in the reclaim unit B 127 is to occur soon (e.g., even without sending a folding request to accelerate the invalidation). When the remaining data in the reclaim unit A 125 is to have a much longer life than the remaining data in the reclaim unit B 127, it can be advantageous to start garbage collection 147 with the reclaim unit A 125.

For example, the garbage collection manager 113 in the host system 102 can determine which of the reclaim units 125 and 127 is going to have a less amount of valid data after a next time window that extends beyond the time of the usage level indicator 140 reaching the condition 145. The determination can be based on the operations to be performed in the host system 102 during the next time window, such as data invalidation operations performed by the storage space tenants 107, . . . , 109 in response to folding requests. When the garbage collection manager 113 in the host system 102 determines that it is more advantages to start garbage collection 147 with the reclaim unit 125, but predicts that the memory sub-system 101 is more likely to start garbage collection 147 with the reclaim unit 127, the garbage collection manager 113 can send a request to the memory sub-system 101 to change the priority of the memory sub-system 101 in erasing the reclaim units 125 and 127.

For example, to maximize the benefit of write amplification reduction via delaying the garbage collection 147 on the reclaim unit B 127, the garbage collection manager 113 in the host system 102 can be configured to request the memory sub-system 101 to perform garbage collection 147 on the reclaim unit A 125. The memory sub-system 101 is configured to perform garbage collection 147 on reclaim units (e.g., 125) identified by the host system 102, before moving on to further perform garbage collection 147 on other victim reclaim units (e.g., 127) that are identified by the memory sub-system 101 but are not identified by the host system 102.

The garbage collection manager 113 in the host system 102 can be configured to send a garbage collection command/request to the memory sub-system 101 to perform garbage collection on reclaim unit A 125. The reclaim unit A 125 can be identified via one or more logical addresses (e.g., 173) having data stored in the reclaim unit A 125. The memory sub-system 101 is configured to track the victim reclaim units (e.g., 125) identified by the host system 102. After the usage level indicator 140 reaches the condition 145 for garbage collection 147, the garbage collection manager 113 in the memory sub-system 101 can prioritize the performing of garbage collection 147 on the reclaim units (e.g., 125) identified by the host system 102, before selecting other reclaim units (e.g., 127) as victim reclaim units for erasure.

Optionally, the garbage collection manager 113 in the host system 102 can send a prioritized list of victim reclaim units to the memory sub-system 101; and the memory sub-system 101 is configured to perform garbage collection 147 on victim reclaim units in an order as specified by the prioritized list. In some implementations, the prioritized list of victim reclaim unit can be specified via one garbage collection request. Alternatively, or combination, the prioritized list of victim reclaim unit can be specified via a sequence of garbage collection requests.

Optionally, the garbage collection manager 113 in the host system 102 can estimate a remaining life of residual data in a victim reclaim unit (e.g., 125) and request the memory sub-system 101 to perform garbage collection 147 on the victim reclaim unit (e.g., 125) using a data placement directive selected to group the residual data with other data having a similar life. The memory sub-system 101 can buffer the request for processing when the usage level indicator 140 reaches the condition 145 for triggering garbage collection 147. During the garbage collection 147 to copy valid data from the victim reclaim unit (e.g., 125), the memory sub-system 101 can retrieve the valid data from the victim reclaim unit (e.g., 125) and write the retrieved valid data according to the data placement directive specified by the host system 102, as if the host system 102 had sent a write (e.g., 171) containing the data placement directive (e.g., 175) for writing the retrieved valid data. Thus, the remaining valid data can be written to a reclaim unit (e.g., 129) that hosts other data having a life similar to the remaining life of the residual data retrieved from the victim reclaim unit (e.g., 125).

Optionally, the memory sub-system 101 can provide a response to the garbage collection request from the host system 102 to indicate the new placement location of valid data that has been relocated during the garbage collection 147.

For example, the memory sub-system 101 can perform garbage collection 147 on a victim reclaim unit 125 without the host system 102 sending a garbage collection request identifying the reclaim unit 125 as a victim reclaim unit and/or without the host system 102 specifying a data placement directive for writing of the residual data retrieved from the victim reclaim unit 125. The memory sub-system 101 can select a data placement directive for the writing of the remaining valid data retrieved from the victim reclaim unit 125 and write the retrieved data to another reclaim unit according to the data placement directive selected by the memory sub-system 101. In the garbage collective response, the memory sub-system 101 can identify the data placement directive used in writing the collected data such that the garbage collection manager 113 in the host system 102 is informed of the new placement location of the remaining valid data.

When the memory sub-system 101 performs garbage collection 147 on a victim reclaim unit 125 in response to a garbage collection request that specifies a data placement directive, the memory sub-system 101 can also optionally report, in the garbage collection response, the data placement directive used to write the residual data.

When the memory sub-system 101 performs garbage collection 147 on a victim reclaim unit 125 without a garbage collection request from the host system 102, the memory sub-system 101 can select a data placement directive for the writing of the remaining valid data collected from the victim reclaim unit 125. For example, the memory sub-system 101 can select the data placement directive based on an estimate or prediction of remaining life of the valid data, or a default data placement directive configured for garbage collection 147 in general.

The memory sub-system 101 can preemptively provide the garbage collective responses, without receiving corresponding garbage collection requests from the host system 102, to report the performance of the garbage collection 147 on the victim reclaim unit 125. The memory sub-system 101 can identify, in the garbage collection responses, the logical address of the residual data being relocated and/or the data placement directive used in writing the residual data, such that the garbage collection manager 113 in the host system 102 is informed of the new placement location of the valid residual data that has been moved.

Optionally, a predetermined data placement directive is used to write data collected during garbage collection 147. Thus, the garbage collection responses can identify the data being moved during garbage collection 147 without specifying the data placement directive used to write the data to their new locations during garbage collection 147.

When garbage collection 147 is performed on a victim reclaim unit 125 according to a garbage collection request that specifies a data placement directive, a response to the garbage collection request can include the identification of data being moved and optionally the data placement directive. Reporting the relevant information in the garbage collection responses by the memory sub-system 101 relieves the host system 102 from tracking the garbage collection requests and/or the data placement directives specified for the requests.

In general, there can be a time gap between the host system 102 sending a garbage collection request identifying a victim reclaim unit 125, and the garbage collection 147 being performed on the victim reclaim unit 125. During the time gap, a storage space tenant (e.g., 107) can invalid at least a portion of the remaining valid data on the victim reclaim unit 125. The memory sub-system 101 can identify, at the time of performing garbage collection 147 on the victim reclaim unit 125, the valid data remaining in the victim reclaim unit 125, and move the valid data to outside of the victim reclaim unit 125. Upon completion of moving the valid data, the memory sub-system 101 can report, to the host system 102 via a garbage collection response, the data being moved during the garbage collection 147 and their new placement locations in reclaim units (e.g., 129) (e.g., as indicated by the data placement directives used to write the data being moved). The garbage collection response can be used by the host system 102 to update the data placement information 180 for improved accuracy in tracking data placement in the memory sub-system 101.

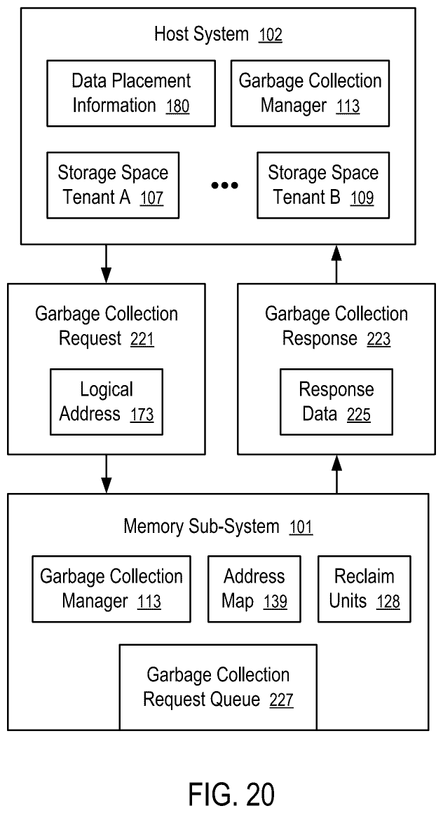

FIG. 20 shows garbage collection in a memory sub-system to target a reclaim unit identified by a host system for erasure according to one embodiment. For example, the technique of FIG. 20 can be implemented in a computing system 100 of FIG. 1 in combination with techniques of FIG. 2 to FIG. 19.

In FIG. 20, the garbage collection manager 113 in the host system 102 can track data placement information 180 (e.g., based on data placement directives 175 specified in write commands 171, as in FIG. 10) to identify a victim reclaim unit (e.g., 125) prioritized for garbage collection 147 in the memory sub-system 101.

For example, the victim reclaim unit (e.g., 125) can be identified based on logical address 173 remaining in association with a reclaim unit identification 177, as in FIG. 13.

For example, onset of the garbage collection 147 can be triggered in the memory sub-system 101 based on the usage level indicator 140 reaches the condition 145, as in FIG. 2.

To erase the victim reclaim unit (e.g., 125), the garbage collection manager 113 in the memory sub-system 101 is configured to copy 159 residual valid data from the victim reclaim unit (e.g., 125) to outside of the victim reclaim unit (e.g., 125), as in FIG. 7.

As in FIG. 2, the memory sub-system 101 can have storage resources 130 organized into a set of reclaim units 128. Using data placement directives (e.g., 175) provided in write commands (e.g., 171), the host system 102 can specify which logical addresses (e.g., 173) are grouped together for having storage spaces implemented in which reclaim units (e.g., 125). When the host system 102 determines that there are only a small number of logical addresses 173 that are remaining as being hosted in a reclaim unit (e.g., represented by a reclaim unit identification 177), the host system 102 can request the memory sub-system 101 to prioritize the garbage collection 147 on the reclaim unit (e.g., 125) hosting the logical address (e.g., 173) (and other remaining logical addresses in association with the reclaim unit identification 177 in the data placement information 180).

To ensure that the memory sub-system 101 targets the victim reclaim unit (e.g., 125) for erasure during the operation of garbage collection 147, the host system 102 is configured to send a garbage collection request 221 that is configured with data that identifies the victim reclaim unit (e.g., 125) to the memory sub-system 101.

For example, the garbage collection request 221 can include the logical address 173 to implicitly identify the victim reclaim unit 125 that provides the storage space for the logical address 173.

Optionally, the garbage collection request 221 can include all of the logical addresses remaining in association the reclaim unit identification 177 in the data placement information 180. Alternatively, the garbage collection request 221 can include one or more logical addresses (e.g., 173) as examples of logical addresses hosted on a victim reclaim unit (e.g., 125) identified by the host system 102.

Optionally, the garbage collection request 221 can specify an ordered list of logical addresses (e.g., 173) of one or more victim reclaim units (e.g., 125, 127) identified by the host system 102.

The memory sub-system 101 can enter the request 221 in the garbage collection request queue 227 for processing after the garbage collection 147 being triggered (e.g., when the usage level indicator 140 satisfies the condition 145).

During the time period between the reception of the garbage collection request 221 and the onset of garbage collection 147, the storage space tenants 107, . . . , 109 in the host system 102 can send, to the memory sub-system 101, commands that result in the data at the victim reclaim units (e.g., 125, 127) being invalidated. For example, the commands can be sent to deallocate 153 a logical address (e.g., 173) identified in a garbage collection request 221, overwrite 155 data at a logical address (e.g., 173) identified in a garbage collection request 221, delete data from a logical address (e.g., 173) identified in a garbage collection request 221, etc. In response to execution of such commands, the garbage collection manager 113 in the memory sub-system 101 can update the corresponding garbage collection request 221 to exclude the corresponding logical address (e.g., 173) from the garbage collection requests (e.g., 221) in the queue 227.

For example, when the request 221 is received to include a logical address 173 as an example of being hosted in a victim reclaim unit 125, the memory sub-system 101 can identify the victim reclaim unit 125 using its address map 139, determine other logical addresses being hosted in the same victim reclaim unit 125, and add such logical addresses to the request 221 for entering into the queue 227.

Alternatively, instead of tracking the logical addresses (e.g., 173) that are hosted in the victim reclaim unit 125, the garbage collection manager 113 can add an identification of the victim reclaim unit 125 to the request 221 for entering into the queue 227.

For example, when the memory sub-system 101 receives the garbage collection request 221, the garbage collection manager 113 in the memory sub-system 101 can use the address map 139 to look up the identity of the victim reclaim unit 125 as known to the memory sub-system 101, and enter the identity of the victim reclaim unit 125 into the queue 227. The identities of the victim reclaim units (e.g., 125) can be entered into the queue 227 in the order of garbage collection requests 221 that identify the victim reclaim units (e.g., 125); and during garbage collection 147, the victim reclaim units (e.g., 125) are processed for erasure in the order corresponding to the order of garbage collection requests 221 that identify the victim reclaim units (e.g., 125).

When the identities of the victim reclaim units (e.g., 125), as known to the memory sub-system 101 and as identified indirectly by the host system 102 using logical addresses (e.g., 173), are documented in the garbage collection queue 227, it is not necessary for the memory sub-system 101 to check commends received before garbage collection 147 to make updates to the list of logical addresses (e.g., 173) in the queue 227.

At the onset of garbage collection 147 (e.g., after the usage level indicator 140 reaches the condition 145), the memory sub-system 101 is configured to prioritize the erasing of the victim reclaim units (e.g., 125) based on the queue 227 of victim reclaim units (e.g., 125) identified by the host system 102. The victim reclaim units (e.g., 125) as identified by the host system 102 are erased before the memory sub-system 101 further selects other victim reclaim units for erasure.

For example, the garbage collection manager 113 in the memory sub-system 101 can copy residual data according to the prioritized list of logical addresses 173 in the queue from the corresponding victim reclaim units (e.g., 125) as identified by the address map 139 to outside of the victim reclaim units (e.g., 125). When a victim reclaim unit (e.g., 125) has no residual valid data, the garbage collection manager 113 in the memory sub-system 101 can erase the victim reclaim unit (e.g., 125) to increase the number of free reclaim units available in the memory sub-system 101.

For example, the garbage collection manager 113 in the memory sub-system 101 can process the sequential erasure of the victim reclaim units identified in the queue 227 according to the order identified by the host system 102. To erase a victim reclaim unit (e.g., 125), the garbage collection manager 113 can copy 159 residual valid data remaining in the victim reclaim unit (e.g., 125) at the time of garbage collection 147 to another reclaim unit (e.g., 129), as in FIG. 7.

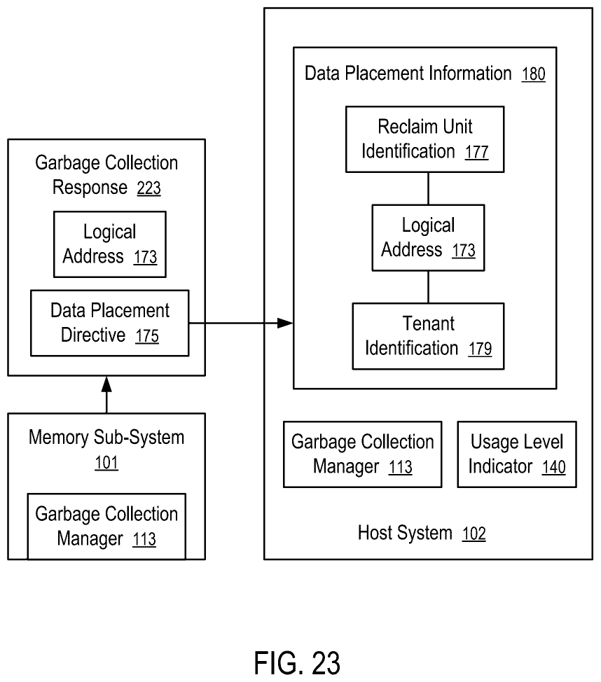

After relocating the valid data for the erasure of the victim reclaim unit (e.g., 125), the garbage collection manager 113 can provide a garbage collection response 223 to the host system 120. The garbage collection manager 113 in the host system 102 can use the response data 225 provided in the garbage collection response 223 to update the data placement information 180, as further discussed in connection with FIG. 23.

In some implementations, the memory sub-system 101 does not postpone the processing of the garbage collection requests (e.g., 221) to after the usage level indicator 140 reaches the condition 145. When the memory sub-system 101 has sufficient bandwidth to process a garbage collection request (e.g., 221) without degrading services to the host system 102, the memory sub-system 101 can start copying data from the victim reclaim unit (e.g., 125) for the erasure of the victim reclaim unit (e.g., 125).

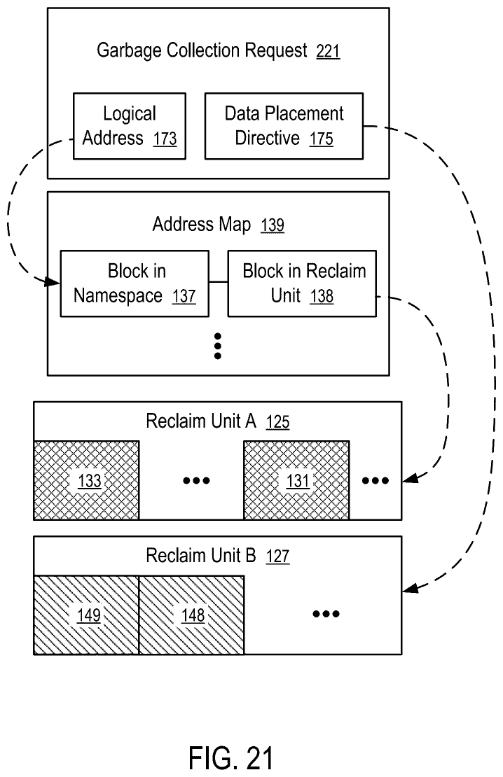

Optionally, the garbage collection request 221 can include a data placement directive 175 to instruct the memory sub-system 101 about data placement in writing the residual valid data collected from the victim reclaim unit (e.g., 125), in a way similar to the data placement directive 175 in a write command 171 instructing the memory sub-system 101 about data placement in writing data, as further discussed in connection with FIG. 21.

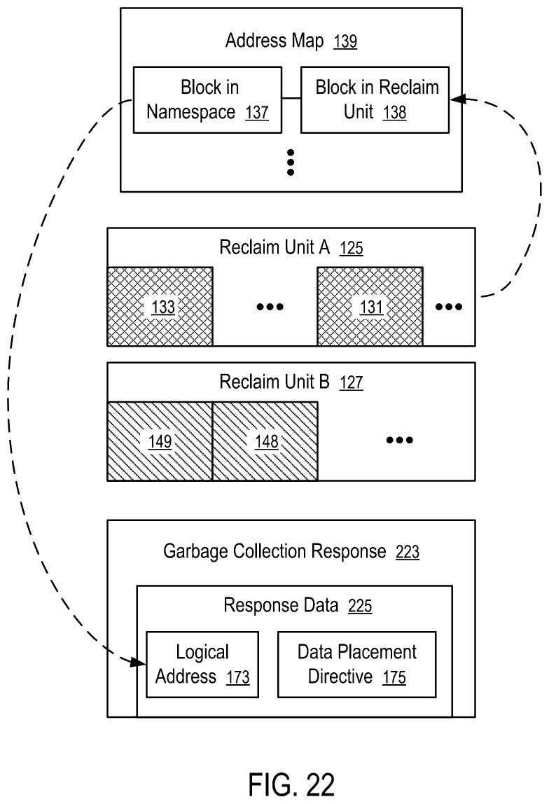

Optionally, the garbage collection response 223 can include a data placement directive 175 used by the memory sub-system 101 to write the residual valid data collected from the victim reclaim unit (e.g., 125), as further discussed in connection with FIG. 22.

FIG. 21 shows a garbage collection request from a host system according to one embodiment. For example, the garbage collection request 221 in FIG. 20 can be implemented and processed in a way as illustrated in FIG. 21.

In FIG. 21, a garbage collection request 221 (e.g., as sent from a host system 102 to a memory sub-system 101 in FIG. 20) is configured to identify a logical address 173 storing valid data in association with a reclaim unit identification (e.g., 177) in the data placement information 180 tracked by the host system 102.

In response to the request 221, the memory sub-system 101 can use its address map 139 at the time of the request 221 to identify a mapping between a logical block 137 in a namespace (e.g., in 121) corresponding to the logical address 173 and a physical block 138 in a reclaim unit (e.g., 125) that provides the physical storage space of the logical block 137. Thus, from the logical to physical block mapping, the memory sub-system 101 can identify a reclaim unit 125 that provides, at the time of the receiving the garbage collection request 221, the physical storage space for the local address 173. The memory sub-system 101 is configured to store data in the garbage collection queue 227 to identify the reclaim unit 125 as a victim reclaim unit suggested by the host system 102.

For example, the memory sub-system 101 can enter, in a garbage collection queue 227, an identification of the reclaim unit 125 as known to the memory sub-system 101 and optionally discard the identification of the logical address 173 provided in the request 221. Based on the address map 139, the memory sub-system 101 can identify the set of logical addresses currently being hosted in the reclaim unit 125.

During garbage collection 147, the memory sub-system 101 can determine whether the address map 139 indicates that any logical address (e.g., 173) is still remaining being validly hosted in the reclaim unit 125; and if so, the memory sub-system 101 is to retrieve the data of the logical address 173 and write the retrieved data to outside of the reclaim unit 125. In some instances, the block in the reclaim unit 125 previously used to provide the storage space for the logical address 173 at the time of the reception of the garbage collection request 221 can no longer store valid data at the time of garbage collection 147. For example, between the reception of the request 221 and the time of garbage collection 147, a storage space tenant (e.g., 107) can send a command that results in the invalidation of the data in the block 131. If so, the memory sub-system 101 can skip garbage collection 147 for the logical address 173 as identified in the request 221, since the reclaim unit 125 no longer stores valid data for the logical address 173.

In FIG. 21, the garbage collection request 221 further includes a data placement directive 175 for the writing of the valid data collected from the victim reclaim unit 125 to outside of the victim reclaim unit 125. For example, the data placement directive 175 can specify a reclaim unit handle to be used by the memory sub-system 101 to write the data collected from the reclaim unit 125 during garbage collection 147. Thus, relocating the data at the logical address 173 from the reclaim unit 125 during garbage collection 147 is functionally equivalent to the host system 102 sending a read command to retrieve the data from the logical address 173 and then sending a write command to write the retrieved data with the data placement directive 175 back to the same logical address 173. However, the data relocation implemented according to the garbage collection request 221 can be performed entirely within the memory sub-system 101 without the memory sub-system 101 sending the data retrieved from logical address 173 to the host system 102 and without the memory sub-system 101 receiving the data back from the host system 102 for writing to the same logical address 173. Thus, the use of the garbage collection request 221 is more efficient than the use of a combination of a read command and a write command. After the garbage collection 147 of the victim reclaim unit 125 according to the data placement directive 175, the data of the logical address 173 is physically stored into a different reclaim unit 127 according to the data placement directive 175.

After relocating the residual valid data to the reclaim unit 127, the memory sub-system 101 can update the address map 139 to indicate the new placement location of the logical block 137 corresponding to the logical address 173.

For example, before the garbage collection 147, the identification of the physical block 138 associated with the logical block 137 in the address map 139 identifies the block 131 of storage resources in the reclaim unit 125 as the physical storage space of the data stored at the logical address 173. After data is written to the block 148 in the reclaim unit 127 according to the data placement directive 175 during the garbage collection 147, the identification of the physical block 138 is updated to identify the block 148 of storage resources in reclaim unit 127 as the physical storage space of the data stored at the logical address 173.

In some implementations, the memory sub-system 101 is configured to use the data placement directive 175 to write all of the residual valid data collected from the reclaim unit 125 during garbage collection 147 to erase the reclaim unit 125. Thus, it is not necessary for the host system 102 to identify a data placement directive 175 separately for each logical address 173 having valid data remaining in the reclaim unit 125 at the time of the generation of the garbage collection request 221.

In some instances, logical addresses (e.g., 173) remaining validly hosted in the victim unit 125 can be divided into a plurality of groups, each having a different remaining life suitable to be written to a separate reclaim unit for grouping with data of a similar life. Thus, the garbage collection request 221 can specify a list of logical addresses 173 for a group to be garbage collected using a same data placement directive 175.

Optionally, the garbage collection request 221 can specify a range or region of logical addresses 173 in a namespace 121 to be garbage collected using a same data placement directive 175. The range or region of logical addresses 173 can be in one or more victim reclaim units (e.g., 125) at the time of the garbage collection request 221.

During the garbage collection 147 to erase the victim reclaim unit 125, if the memory sub-system 101 determines that a block remaining valid in the reclaim unit 125 does not have a data placement directive (e.g., 175) explicitly specified by the host system 102 for writing the collected residual data, the memory sub-system 101 can use a last data placement directive 175 that is sent by the host system 102 in a garbage collection request (e.g., 221) targeting a logical address (e.g., 173) hosted in the same reclaim unit 125. Such a last data placement directive 175 specified for the same reclaim unit 125 can be used as the default data placement directive 175 for writing the residual data collected from the reclaim unit 125.

FIG. 22 shows a garbage collection response from a memory sub-system according to one embodiment. For example, the garbage collection response 223 in FIG. 20 can be generated in a way as illustrated in FIG. 22.

In some instances, the memory sub-system 101 can start garbage collection 147 on the victim reclaim unit 125, after the usage level indicator 140 reaches the condition 145 (e.g., as in FIG. 2) but without the host system 102 identifying the reclaim unit 125 (e.g., via a request 221). The garbage collection response 223 can be generated by the memory sub-system 101 to inform the host system 102 of the new placement location of the residual data collected during the garbage collection 147. In some instances, the garbage collection response 223 is generated in response to a corresponding garbage collection request 221.

In FIG. 22, the address map 139 in the memory sub-system 101 contains a mapping between the logical block 137 in a namespace (e.g., 121) to the identification of a physical block 138 in the storage resources 130 in the memory sub-system 101.

Before the garbage collection 147 on the victim reclaim unit 125, the identification of the physical block 138 corresponds to a block (e.g., 131) in the victim reclaim unit 125. In general, the victim reclaim unit 125 be identified by a host system 102 via a garbage collection request (e.g., 221 in FIG. 21), or by the memory sub-system 101 based on a set of selection criteria internal to the memory sub-system 101.

During the garbage collection 147, the memory sub-system 101 can determine that the block 131 has valid data remaining in the victim reclaim unit 125. In order to erase the reclaim unit 125 without losing the valid data, the memory sub-system 101 retrieves the data from the block 131 and writes the data to a block (e.g., 148) in another reclaim unit 127 using a data placement directive 175, in a way similar to writing data in response to a write command 171 having a data placement directive 175. The memory sub-system 101 then updates the mapping in the address map 139 to indicate that the physical storage space for the logical block 137 is now in the block 148 in the reclaim unit 127 via an updated identification of the physical block 138 identified in the address map 139.

To inform the host system 102 of the new data placement location of the logical address 173, the memory sub-system 101 can generate a garbage collection response 223 that identifies the logical address 173 and the data placement directive 175 used in writing the data retrieved from the victim reclaim unit 125. The host system 102 can update its data placement information 180 according to the garbage collection response 223, as illustrated in FIG. 23.

In some instances, the garbage collection response 223 is in response to a corresponding garbage collection request 221 that specifies the data placement directive 175 for the logical address 173. The garbage collection response 223 identifies the same data placement directive 175 specified in the request 221.

In some instances, the garbage collection response 223 is in response to a corresponding garbage collection request 221 that specifies the data placement directive 175 for another logical address hosted in the victim reclaim unit 125 without the logical address 173 being explicitly identify by the host system 102 via a garbage collection request 221. The memory sub-system 101 can use the data placement directive 175 provided in the last garbage collection request 221 targeting the victim reclaim unit 125 to write the residual data collected for the logical address 173. The memory sub-system 101 is configured to report the use of the data placement directive 175 in the garbage collection response 223.

In some instances, the garbage collection response 223 is generated without the reclaim unit 125 being identified as a victim reclaim unit by the host system 102. The memory sub-system 101 can use a default data placement directive 175 to write the residual data collected from the reclaim unit 125. The memory sub-system 101 can identify the data placement directive 175 in the garbage collection response 223 to inform the host system 102 about the data placement relocation.

FIG. 23 shows a host system updating data placement information based on a garbage collection response from a memory sub-system according to one embodiment. For example, after the memory sub-system provides a garbage collection response 223 as in FIG. 22, the host system 102 can update its data placement information 180 as in FIG. 23.

In FIG. 23, the garbage collection manager 113 in the host system 102 is configured to identify the reclaim unit identification 177 that is associated with, in the data placement information 180, the logical address 173 identified in the garbage collection response 223. Based on the data placement directive 175 identified in the garbage collection response 223, the garbage collection manager 113 in the host system 102 can determine an updated reclaim unit identification 177, in a way similar to the determination of the reclaim unit identification 177 for a write command 171 (e.g., as in FIG. 10), as if the garbage collection response 223 were a write command to be sent to the memory sub-system 101 to write data at the logical address 173.

Based on the updated data placement information 180, the garbage collection manager 113 can determine the usage level indicator 140 (e.g., as in FIG. 10) with improved accuracy.

Further, based on the updated data placement information 180, the garbage collection manager 113 can perform host folding 143 and/or determine time estimates (e.g., as in FIG. 13) with improved accuracy.

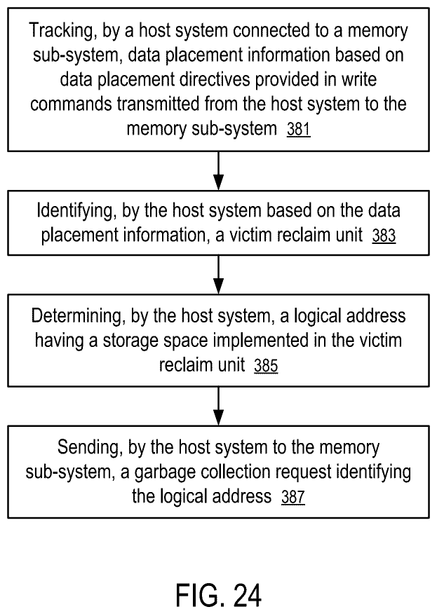

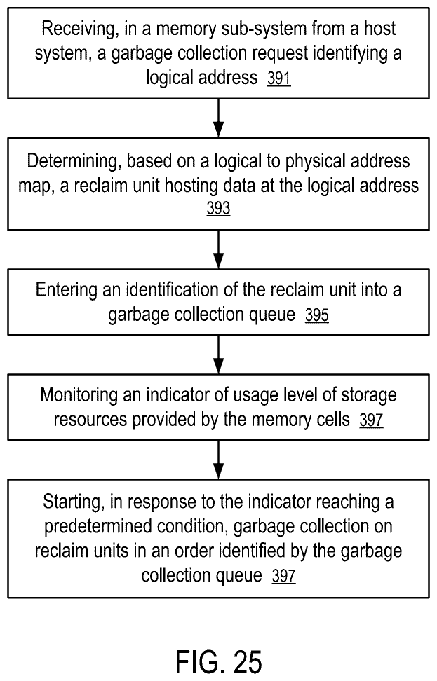

FIG. 24 to FIG. 25 show methods to perform garbage collection according to one embodiment. The methods of FIG. 24 to FIG. 25 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the methods of FIG. 24 to FIG. 25 are performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the methods of FIG. 24 and FIG. 25 can be implemented using the garbage collection managers 113 of FIG. 1 to perform the operations discussed in connection with FIG. 2 to FIG. 23.

At block 381, the method of FIG. 24 includes tracking, by a host system 102 connected to a memory sub-system 101, data placement information 180 based on data placement directives (e.g., 175) provided in write commands (e.g., 171) transmitted from the host system 102 to the memory sub-system 102.

At block 383, the method includes identifying, by the host system 102 based on the data placement information 180, a victim reclaim unit (e.g., 125).

At block 385, the method includes determining, by the host system 102, a logical address (e.g., 173) having a storage space implemented in the victim reclaim unit (e.g., 125).

At block 387, the method includes sending, by the host system 102 to the memory sub-system 102, a garbage collection request 221 identifying the logical address 173.

For example, the method can further include specifying, by the host system 102, a data placement directive 175 in the garbage collection request 221 (e.g., as in FIG. 21).

For example, the method can further include determining, by the host system 102, a remaining life of data at the logical address 173 hosted in the victim reclaim unit 125, and selecting, by the host system 102, the data placement directive 175 based at least in part on the remaining life.

For example, the garbage collection manager 113 in the host system 102 can be configured to communicate with storage space tenants (e.g., 107, . . . , 109) to estimate expiration time 305 of data stored at the logical address 173 (e.g., as in FIG. 13). The remaining life of data at the logical address 173 can be based on the expiration time 305. Alternatively, or in combination, the remaining life of data at the logical address 173 can be based on a prediction from a predictive model 353 (e.g., as in FIG. 17).

For example, the memory sub-system 101 can be configured to start garbage collection 147 after an indicator 140 of usage level of storage resources 130 reaches a predetermined condition 145 (e.g., as in FIG. 2); and the method can further include monitoring, by the host system 102, the indicator 140 of usage level of storage resources 130 to send the garbage collection request 221 before the indicator 140 reaches the predetermined condition 145 for triggering garbage collection 147 in the memory sub-system 101.

For example, the victim reclaim unit 125 is a first reclaim unit 125; and the method further includes reaching, by the host system 102, a determination/prediction that the memory sub-system 125 is to perform garbage collection 147 on a second reclaim unit 127 before performing garbage collection 147 on the first reclaim unit 125. When the garbage collection manager 113 in the host system 102 determines that it is advantageous for the memory sub-system 101 to perform garbage collection 147 on the first reclaim unit 125 before performing garbage collection 147 on the second reclaim unit 127, the host system 102 can send the garbage collection request 221 to cause the memory sub-system to perform garbage collection 147 on the first reclaim unit 125 before performing garbage collection 147 on the second reclaim unit 127.

For example, the determination/prediction that the memory sub-system 125 is to perform garbage collection 147 on the second reclaim unit 127 before performing garbage collection 147 on the first reclaim unit 125 can be based on a prediction that valid data remaining in the second reclaim unit 127 has an amount that is smaller than valid data remaining in the first reclaim unit 125 at onset of garbage collection 147 in the memory sub-system 101 when the indicator reaches the condition 145.

For example, the method can further include estimating, by the host system 102, amounts of valid data remaining in the first reclaim unit 125 and the second reclaim unit 127 respectively after a time period following the onset of garbage collection 147 in the memory sub-system 101. If, after the time period following the onset of garbage collection 147 in the memory sub-system 101, an amount of valid data remaining in the first reclaim unit 125 is smaller than an amount of valid data remaining in the second reclaim unit 127, it is advantageous to cause the memory sub-system 101 to perform garbage collection 147 on the first reclaim unit 125 before performing garbage collection 147 on the second reclaim unit 127. Thus, the garbage collection request 221 can be sent to prevent the memory sub-system 101 from performing garbage collection 147 on the second reclaim unit 127 before performing garbage collection 147 on the first reclaim unit 125.

The method of FIG. 25 can be performed after the garbage collection request 221 is sent by the garbage collection manager 113 in the host system 102 to the memory sub-system 101.

At block 391, the method of FIG. 25 includes receives, in the memory sub-system 101 and from the host system 102, the garbage collection request 221 identifying the logical address 137.

At block 393, the method further includes determining, by the garbage collection manager 113 in the memory sub-system 101 and based on a logical to physical address map 139, a reclaim unit 125 hosting data at the logical address 137 and thus the victim reclaim unit 125 identified by the host system 102 via the garbage collection request 221.

At block 395, the method further includes entering an identification of the reclaim unit 125 into a garbage collection queue 227 in the memory sub-system 101.

At block 397, the method further includes the memory sub-system 101 monitoring an indicator 140 of usage level of storage resources 130 provided by memory cells (e.g., 114) in the memory sub-system 101.

At block 397, the method further includes the garbage collection manager 113 in the memory sub-system 101 starting, in response to the indicator 140 reaching the predetermined condition 145, garbage collection 147 on reclaim units 128 in an order identified by the garbage collection queue 227.

The garbage collection manager 113 in the memory sub-system 101 does not perform operations to select victim reclaim units before the indicator 140 reaches the condition 145. Thus, the victim reclaim units (e.g., 125) identified by the host system 102 and queued in the garbage collection request queue 227 can be processed with a higher priority than, and thus before, any victim reclaim units that are selected by the garbage collection manager 113 after the indicator 140 reaches the condition 145.

For example, the method can further include extracting, by the memory sub-system 101, from the garbage collection request 221, a data placement directive 175, and performing garbage collection 147 on the victim reclaim unit 125 identified by the host system 102 using the data placement directive 175. For example, the controller 115 of the memory sub-system 101 can be configured to retrieve, from the victim reclaim unit 125, valid data remaining in the reclaim unit 147 during garbage collection 147, and to write the valid data according to the data placement directive 175. For example, the controller 115 of the memory sub-system 101 can identify another reclaim unit 127 based on the data placement directive 175 to write the valid data to the reclaim unit 127 identified according to the data placement directive 175.

Upon completion of writing the valid data to the reclaim unit 127 identified according to the data placement directive 175, the controller 115 can further update the logical to physical address map 139 to indicate that the logical address 172 is hosted in the reclaim unit 127.

Optionally, upon completion of writing the valid data to the reclaim unit 127 identified according to the data placement directive 175, the controller 115 can generate a garbage collection response 223 identifying one or more logical addresses (e.g., 173) having the valid data written to the reclaim unit 127, as in FIG. 22. Optionally, the controller 115 can further specify, in the garbage collection response 223, the data placement directive 175 used to identify the reclaim unit 127 and/or to write the valid data.

After the garbage collection response 223 is transmitted from the memory sub-system 101 to the host system 102, the garbage collection manager 113 in the host system 102 can update, according to the garbage collection response 223, the data placement information 180, as in FIG. 23.

Optionally, after the memory sub-system 101 completes performing garbage collection 147 on victim reclaim units (e.g., 125) identified by the host system 102 via garbage collection requests (e.g., 221), the memory sub-system 101 can further selection victim reclaim units not identified by the host system 102. Upon completion of relocating valid data from a victim reclaim unit selected by the memory sub-system 101, the garbage collection manager 113 in the memory sub-system 101 can generate a garbage collection response to report the data relocation without a corresponding garbage collection request.

In some situations, it can be advantageous for the host system 102 to actively drive the operations of garbage collection 147 (e.g., at least for a period of time to remove the uncertainty associated with the memory sub-system 101 performing garbage collection 147 on its own initiative).

For example, the memory sub-system 101 can be configured to, or be instructed by the host system 102 to, stop starting garbage collection 147 based on the indicator 140, and/or stop selecting victim reclaim units. Thus, the host system 102 is to control the selection of victim reclaim units for erasure and/or the timing of retrieval of residual valid data from victim reclaim units for the erasure of the victim reclaim units. The host system 102 can take over the responsibility of managing the selection of victim reclaim units and the invalidation of remaining residual data in victim claim units for their erasure to prevent degradation of the performance of the memory sub-system 101 due to the lack of available free reclaim units.

For example, the host system 102 can be configured to send a command to the memory sub-system 101 to prevent the memory sub-system 101 from selecting victim reclaim units (e.g., 125) for collecting residual valid data and thus for their erasure. In response to the command, the memory sub-system 101 is configured to erase a reclaim unit (e.g., 125) only when the reclaim unit (e.g., 125) has no residual valid data (and thus no need to perform garbage collection 147 on the reclaim unit 125) or in response to a garbage collection request (e.g., 221) from the host system 102.

For example, when the usage level indicator 140 reaches a condition 141 for host folding 143, the host system 102 can start operations to select victim reclaim units (e.g., 125) and to accelerate invalidation of remaining valid data in the victim reclaim units (e.g., 125), e.g., as FIG. 2 to FIG. 19.

When the memory sub-system 101 completes a command (e.g., to deallocate 153, overwrite 155, delete) received from the host system 102 that invalidates at least a portion of data stored on a reclaim unit (e.g., 125), the memory sub-system 101 can check whether the reclaim unit (e.g., 125) has any residual valid data; and if not, the memory sub-system 101 can erase the reclaim unit (e.g., 125) to increase the number of available, free reclaim units, or schedule the erasure of the reclaim unit (e.g., 125) at a suitable time (e.g., idle time or a time of low workload) to reduce its impact on the performance of the memory sub-system 101 in servicing the host system 102.

Optionally, the host system 102 can send a garbage collection request 221 to identify a victim reclaim unit (e.g., 125) (e.g., as in FIG. 20). In response, the memory sub-system 101 can process the garbage collection request 221 (e.g., as in FIG. 21 and FIG. 22). Upon completion of the processing the garbage collection request 221, the victim reclaim unit (e.g., 125) has no residual valid data; and the memory sub-system 101 can erase the reclaim unit (e.g., 125) immediately, or at a later time to reduce its impact on the performance of the memory sub-system 101 in servicing the host system 102.

Optionally, the memory sub-system 101 can process the garbage collection request 221 immediately upon reception. Alternatively, the memory sub-system 101 can schedule the processing via a garbage collection request queue 227 at a later time to reduce its impact on the performance of the memory sub-system 101 in servicing the host system 102 and to maximize write amplification reduction (since some of the data in the reclaim unit (e.g., 125) can be invalidated during normal operations of storage space tenants).

For example, the host system 102 can predict whether there is a need for a free reclaim unit based on the data placement information 180. When the need is predicted, the host system 101 can start host folding 143 at a time period before predicted need. When host folding 143 fails to complete in time by the storage space tenants (e.g., 107) of victim reclaim units (e.g., 125) identified by the host system 102, the host system 102 can move valid data from one claim unit (e.g., 125) to another to complete folding the reclaim unit (e.g., 125). If the memory sub-system 101 supports garbage collection requests (e.g., 221), the host system 102 can move the valid data via sending one or more garbage collection requests (e.g., 221). If the memory sub-system 101 does not support garbage collection requests, the host system 102 can move the valid data via sending one or more read commands to retrieve the valid data and one or more write commands to store the retrieved valid data back to an alternative reclaim unit. Optionally, the host system 102 can cache the residual valid data outside of the memory sub-system 101 in anticipate of the data to used/invalidated soon.

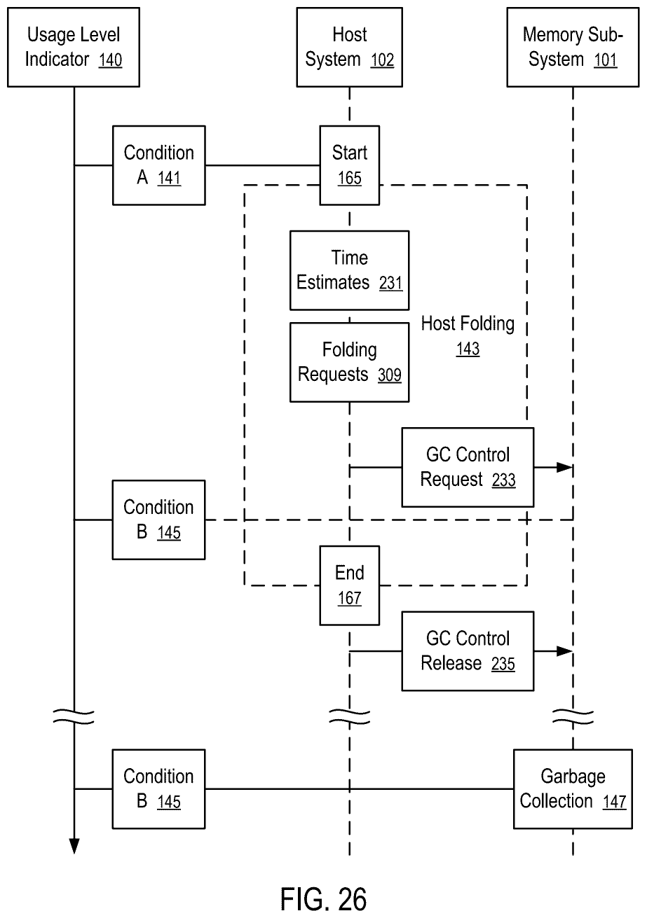

FIG. 26 to FIG. 28 show techniques to transfer garbage collection control according to some embodiments. For example, the techniques of FIG. 26 can be implemented in a computing system 100 of FIG. 1 in combination with the techniques of FIG. 2 to FIG. 23.

In FIG. 26, an indicator 140 of usage level of storage resources 130 in a memory sub-system 101 can change over time.

The host system 102 uses data placement directives (e.g., 175) in the write commands (e.g., 171) to direct the memory sub-system 101 to place the data to be written in reclaim units (e.g., 125, 127, . . . , 129), as in FIG. 10. Further, when residual data is collected from victim reclaim units (e.g., 125) for the erasure of the victim reclaim units (e.g., 125), the writing of the residual data can be in accordance with the data placement directive (e.g., 175) provided by the host system 102 in the garbage collection requests (e.g., 221 as in FIG. 21) and/or reported by the memory sub-system 101 via garbage collection responses (e.g., 223 as in FIG. 22). Thus, the host system 102 can evaluate the indicator 140 based on its tracked information (e.g., data placement information 180).

When the indicator 140 reaches a condition 141, the host system 102 can start 165 to send requests (e.g., 301) for time estimate 231 to storage space tenants (e.g., 107) to select victim reclaim units (e.g., as in FIG. 14 and/or FIG. 15).

The operation of host folding 143 can include the garbage collection manager 113 in the host system 102 sending folding requests to storage space tenants (e.g., 107) of victim reclaim units. Optionally, the host system 102 can schedule the sending of the folding requests at time instances such that the storage space tenants (e.g., 107) complete their operations for responding to the folding requests near the time instance at which the indicator 140 reaches the condition 145.

Shortly before the indicator 140 reaches the condition 145, the host system 102 may optionally end 167 its operations of host folding 143 to avoid concurrent execution of host folding 143 and garbage collection 147 in the memory sub-system 101.

For example, when there are pending folding requests (e.g., 309) for which the storage space tenants (e.g., 107) have not yet complete their operations to invalid the data in the victim reclaim units selected by the host system 101, the garbage collection manager 113 in the host system 102 can send requests to the storage space tenants (e.g., 107) to cancel the pending folding requests (e.g., 309).

In some instances, the indicator 140 can approach the condition 145 sooner than expected; and the garbage collection manager 113 may have not yet sent the folding requests for the accelerated invalidation of data in some victim reclaim units (e.g., 125). As the indicator 140 increases to approach the condition 145, the garbage collection manager 113 can cancel the scheduled folding requests that have not yet been sent to the respective storage space tenants (e.g., 107) and thus terminate the host folding 143 without accelerated invalidation of data in the previously selected victim reclaim units (e.g., 125).

When the memory sub-system 101 determines that the usage level indicator 140 reaches the condition 145, the garbage collection manager 113 running in the memory sub-system 101 can start garbage collection 147, as in FIG. 2.

In some instances, the host system 101 can determine that it is advantageous to control the operations of garbage collection 147 and to prevent the memory sub-system 101 from performing garbage collection 147 on its own initiative. When the host system 101 is in control of the operations garbage collection 147, including the selection of victim reclaim units and/or the timing of copying residual data from the victim reclaim units, undesirable effects of running host folding 143 and garbage collection 147 in parallel can be eliminated.

To take control of garbage collection 147, the host system 101 can send a request 233 for garbage collection control before the indicator 140 reaches the condition 145 to trigger garbage collection 147 in the memory sub-system 101. In response, the memory sub-system 101 is configured to retrain from selecting victim reclaim units independently from the host system 102.

After the memory sub-system 101 receives the garbage collection control request 223, the memory sub-system 101 is configured to rely upon to the host system 102 to send commands to move or invalidate data in victim reclaim units (e.g., 125) identified by the host system 102. For example, the host system 102 can perform the host folding 143 to cause data in victim reclaim units (e.g., 125) to be invalidated with acceleration. Further, during the normal operations of the storage space tenants (e.g., 107, . . . , 109), commands can be generated in the host system 102 to invalid data in some reclaim units. When a reclaim unit (e.g., 125) has no valid residual data, the memory sub-system 101 can erase the reclaim unit (e.g., 125) immediately, or schedule the erasure of the reclaim unit (e.g., 125) at an idle time, at a time when the workload is low, at a time when the memory sub-system 101 has free resources to perform the task of erasing the reclaim unit (e.g., 125), or at a time when the lack of a free reclaim unit prevents the memory sub-system 101 from execute a write command.

Thus, after the garbage collection control is transferred from the memory sub-system 101 to the host system 102 via the request 233, the memory sub-system 101 does not start garbage collection 147 even when the usage level indicator 140 reaches the condition 145.

For example, when the host system 102 determines that the indicator 140 is approaching the condition 145 and the host folding 143 is expected to continue in a short period after the indicator 140 reaches the condition 145 to maximize the benefit of host folding 143 in reducing garbage collection 147, the host system 102 sends the request 233 to control garbage collection 147.

After the end 167 of host folding 143, the host system 120 can optionally send a garbage collection control release 235. In response the memory sub-system 101 can monitor the indicator 140 and start garbage collection 147 when the indicator 140 subsequently reaches the condition 145. When the garbage collection 147 is initiated by the memory sub-system 101, the garbage collection manager 113 in the memory sub-system 101 can identify victim reclaim units (e.g., 127) independently from the host system 102 (e.g., after completion of the process the garbage collection queue 227).

FIG. 26 illustrates an example of the host system 102 sending the garbage collection control request 233 during host folding 143 and sending the garbage collection control request 235 after the end of host folding 143. In general, the host system 102 can send a garbage collection control request 233 in response to a determination that the host system 102 has significantly more information than the memory sub-system 101 in best reducing write amplification, and can send garbage collection control release 235 to transfer the task to the memory sub-system 101 when the host system 102 lacks better information to manage garbage collection 147 than the memory sub-system 101.

FIG. 26 shows an example of the host system 102 relying upon sending folding requests to storage space tenants (e.g., 107, . . . , 109) to invalidate data in victim reclaim units (e.g., 125) and thus cause the victim reclaim units (e.g., 125) to be erased.

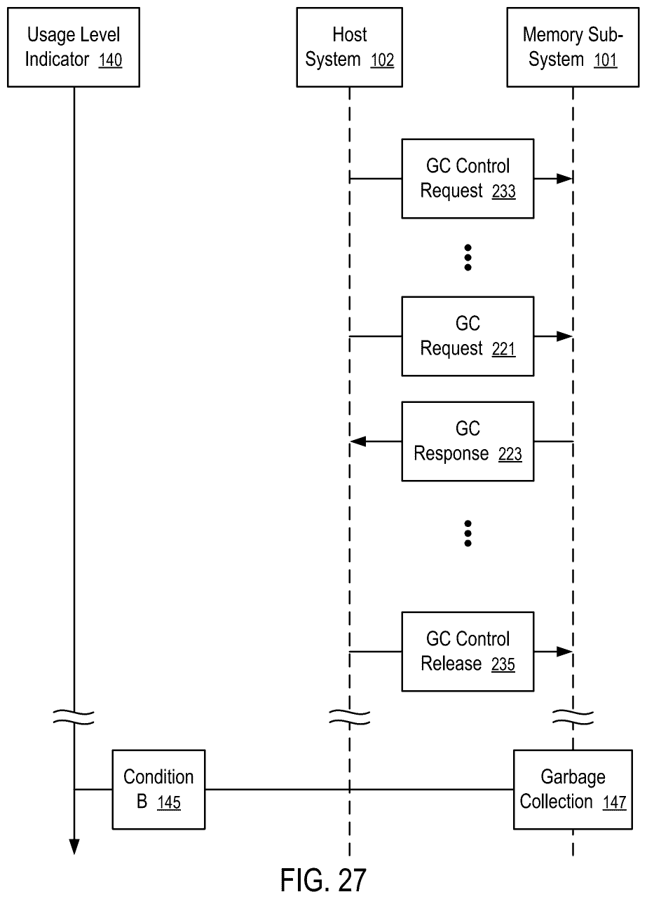

Alternatively, or in combination, the host system 102 can send garbage collection requests (e.g., 221) to invalidate data in victim reclaim units (e.g., 125), as in FIG. 27.

In FIG. 27, after the host system 102 sends the garbage collection control request 233, the host system 102 can send a garbage collection request 221 (e.g., configured as in FIG. 21). In response to the request 221, the memory sub-system 102 can identify remaining valid data in the victim reclaim unit (e.g., 125) identified by the request 221 and copy the valid data to another reclaim unit (e.g., 127 according to the data placement directive provided in the request 221). As a result of data placement relocation caused by the garbage collection request 221, the victim reclaim unit (e.g., 125) has no residual valid data and thus can be erased.

In FIG. 27, the memory sub-system 101 is configured to process the garbage collection request 221 substantially immediately, in a way like the processing of a read and a write command from the host system 102. Thus, the sending of the garbage collection request 121 can be seen the triggering of garbage collection 147 specifically for the victim reclaim unit (e.g., 125) identified in the garbage collection request 121; and the garbage collection 147 as triggered by the request 221 terminates upon the processing of the victim reclaim unit 125 (e.g., without the memory sub-system 101 moving on to identify other victim reclaim units)

Optionally, the host system 102 can determine whether the memory sub-system 101 supports the processing of garbage collection requests (e.g., 221). If so, garbage collection requests (e.g., 221) are sent for improved performance in relocating the residual valid data; otherwise, the host system 102 can send one or more read commands to retrieve the residual valid data from the victim reclaim units (e.g., 125) and then one or more write commands to write the retrieved valid data back to respective logical addresses using a data placement directive that identifies a different reclaim unit for the storage of the data of the logical addresses.

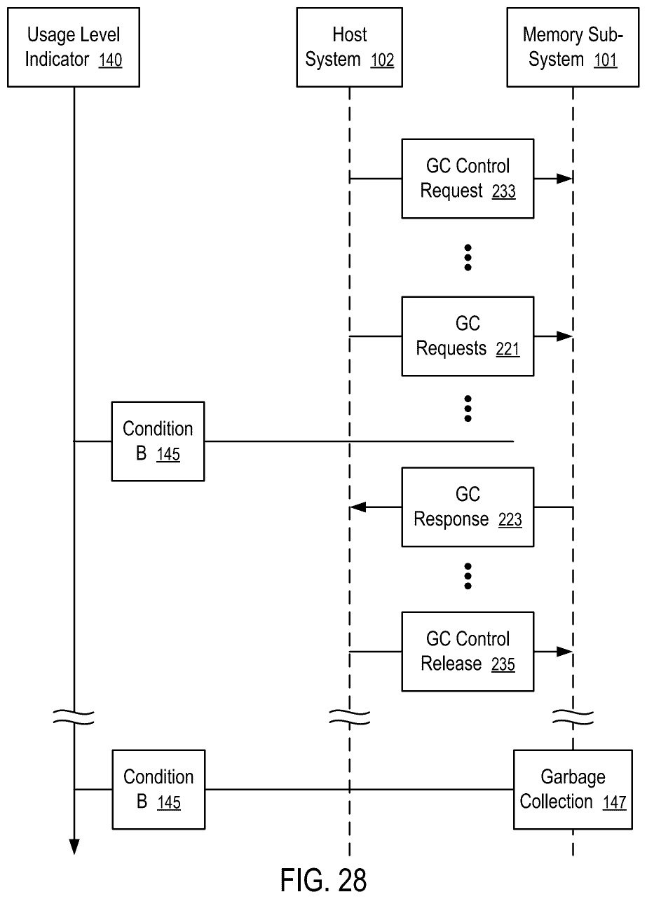

Optionally, the memory sub-system 101 is configured to queue the garbage collection request 221 in a queue 227 for processing after the usage level indicator 140 reaches the condition 145, as in FIG. 28.

In FIG. 28, the memory sub-system 101 is configured to enter, into a queue 227, garbage collection requests 221 received before the indicator 140 reaching the condition 145. After the indicator 140 reaches the condition 145, the memory sub-system 101 is configured to process the queue 227 to generate the garbage collection responses 223. Thus, after the garbage collection control has been transferred to the host system 102 via the control request 233, the indicator 140 reaching the condition 145 can be seen to trigger the garbage collection 147 specifically for the victim reclaim units (e.g., 125) identified by the host system 102 via the garbage collection requests 221. The garbage collection 147 as triggered in such a way terminates upon the processing of the garbage collection queue 227 (e.g., without the memory sub-system 101 moving on to identify other victim reclaim units).

In contrast, after the garbage collection control is released back to the memory sub-system 101, the garbage collection 147 is to be triggered by the indicator 140 reaching the condition 145; and the garbage collection 147 is not limited to the operations (e.g., garbage collection requests 221) identified by the host system 102.

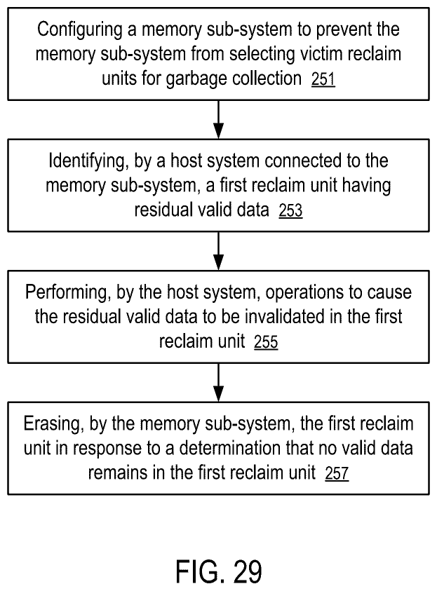

FIG. 29 shows a method to control garbage collection according to one embodiment. The method of FIG. 29 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 29 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 29 can be implemented using the garbage collection managers 113 of FIG. 1 to perform the operations discussed in connection with FIG. 2 to FIG. 28.

At block 251, the method of FIG. 28 includes configuring a memory sub-system 101 to prevent the memory sub-system 101 from selecting victim reclaim units for garbage collection 147.

For example, the configuring of the memory sub-system 101 can include sending a garbage collection control request 233 from the host system 102 to the memory sub-system 101 as in FIG. 26 to FIG. 28.

At block 253, the method includes identifying, by a host system 102 connected to the memory sub-system 101, a first reclaim unit 125 having residual valid data (e.g., stored at a logical address 173 having a storage space implemented in the first reclaim unit 125).

For example, the first reclaim unit 125 can be identified by the host system 102 as a victim reclaim unit to be erased in response to an indicator 140 of usage level of storage resources 130 in the memory sub-system 101 reaching a condition 141 for host folding, as in FIG. 2.

For example, the first reclaim unit 125 can be identified based on data placement information 180 tracked by the host system 102 based on data placement directives (e.g., 175).

At block 255, the method includes performing, by the host system 102, operations to cause the residual valid data to be invalidated in the first reclaim unit 125.

For example, the operations to cause data to be invalidated in the first reclaim unit 125 can include sending a folding request 309 (e.g., as at blocks 319, 329, 339 in FIG. 14 to FIG. 16) to a storage space tenant (e.g., 107) to accelerate invalidation of data at a logical address (e.g., 173) having a storage space implemented in the first reclaim unit 125.

For example, the folding request 309 causes the storage space tenant (e.g., 107) to generate a command to deallocate 153 the logical address 173, to overwrite 155 at the logical address 173, or to delete data from the logical address 173. The execution of the command in the memory sub-system 101 can invalidate the corresponding data stored in the first reclaim unit 125.

Alternatively, or in combination, the operations to cause data to be invalidated in the first reclaim unit 125 can include sending a garbage collection request 221 (e.g., as in FIG. 20, FIG. 27, and FIG. 28) to identify the first reclaim unit 125 to the memory sub-system 101. The garbage collection request 221 causes the memory sub-system 101 to copy remaining valid data from the first reclaim unit 125 to a second reclaim unit (e.g., 127) to invalidate the remaining valid data stored in the first reclaim unit 125.

Optionally, the garbage collection request 211 can include a data placement directive 175 used by the memory sub-system 101 to identify the second reclaim unit 127 for storing the remaining valid data copied from the first reclaim unit 125.

For example, the method can further include: entering, by the memory sub-system 101, an identification of the first reclaim unit 125 into a garbage collection queue 227; and postponing, by the memory sub-system 101, processing requests in the garbage collection queue 227 to after an indicator 140 of usage level of storage resources 130 in the memory sub-system 101 reaches a predetermined condition 145 for garbage collection 147.

Alternatively, the method can further include: processing, by the memory sub-system 101, the garbage collection request 221 for erasure of the first reclaim unit 125 without waiting for the indicator 140 of usage level of storage resources 130 in the memory sub-system 101 to reach the predetermined condition 145 configured to trigger garbage collection 147 in the memory sub-system 101.

Alternatively, or in combination, the operations to cause data to be invalidated in the first reclaim unit 125 can include: determining, by the host system 102, a first logical address 175 having a storage space implemented in the first reclaim unit 125; sending a read command from the host system 102 to the memory sub-system 101 to retrieve, from the first logical address 175, first data; and sending a write command from the host system 102 to the memory sub-system 101 to write the first data back to the first logical address 175 to cause the first data as stored in the first reclaim unit 125 to be invalidated.

At block 257, the method includes erasing, by the memory sub-system 101, the first reclaim unit 125 in response to a determination that no valid data remains in the first reclaim unit 125.

For example, the memory sub-system 101 can erase the first reclaim unit 125 in response to execution of a last command that results in the invalidation of the last remaining block of data in the first reclaim unit 125.

Alternatively, the memory sub-system 101 can enter the first reclaim unit 125 in a queue (e.g., 227) for erasure at a suitable time, such as an idle time, a time when the workload is low, a time when the memory sub-system 101 has free resources to perform the task of erasing the reclaim unit 125, or at a time when the lack of a free reclaim unit prevents the memory sub-system 101 from execute a command from the host system 102.

Optionally, the method can further include: sending a garbage collection control release 235 from the host system 102 to the memory sub-system 101 to cause the memory sub-system 101 to select, after an indicator 140 of usage level of storage resources 130 in the memory sub-system 101 reaches a predetermined condition 145, victim reclaim units for garbage collection 147.

For example, after receiving the garbage collection control release 235, the memory sub-system 101 can perform garbage collection 147 independently without assistance from the host system 102. Optionally, the host system 102 can perform host folding 143 to further reduce write amplification before garbage collection 147 is triggered in the memory sub-system 101.

A non-transitory computer storage medium can be used to store instructions programmed to implement the garbage collection managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

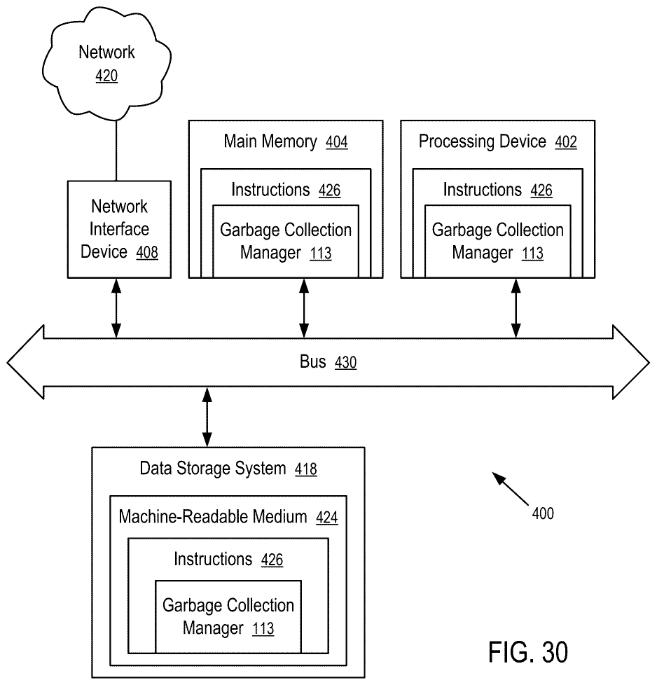

FIG. 30 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of garbage collection managers 113 (e.g., to execute instructions to perform operations corresponding to the garbage collection managers 113 described with reference to FIGS. 1-29). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the garbage collection managers 113 described with reference to FIGS. 1-29. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
configuring a memory sub-system to prevent the memory sub-system from selecting victim reclaim units for garbage collection;
identifying, by a host system connected to the memory sub-system, a first reclaim unit having residual valid data; and
performing, by the host system, operations to cause the residual valid data to be invalidated in the first reclaim unit.

2. The method of claim 1, further comprising:
erasing, by the memory sub-system, the first reclaim unit in response to a determination that no valid data remains in the first reclaim unit;
wherein the configuring of the memory sub-system includes sending a garbage collection control request from the host system to the memory sub-system.

3. The method of claim 2, wherein the operations include sending a folding request to a storage space tenant to accelerate invalidation of data at a logical address having a storage space implemented in the first reclaim unit.

4. The method of claim 3, wherein the folding request causes the storage space tenant to generate a command to deallocate the logical address, to overwrite at the logical address, or to delete data from the logical address.

5. The method of claim 4, wherein the operations further include sending a garbage collection request to identify the first reclaim unit to the memory sub-system;
and wherein the garbage collection request causes the memory sub-system to copy remaining valid data from the first reclaim unit to a second reclaim unit to invalidate the remaining valid data stored in the first reclaim unit.

6. The method of claim 5, wherein the garbage collection request includes a data placement directive used by the memory sub-system to identify the second reclaim unit for storing the remaining valid data copied from the first reclaim unit.

7. The method of claim 6, further comprising:
entering, by the memory sub-system, an identification of the first reclaim unit into a garbage collection queue; and
postponing, by the memory sub-system, processing requests in the garbage collection queue to after an indicator of usage level of storage resources in the memory sub-system reaches a predetermined condition.

8. The method of claim 6, further comprising:
processing, by the memory sub-system, the garbage collection request for erasure of the first reclaim unit without waiting for an indicator of usage level of storage resources in the memory sub-system to reach a predetermined condition configured to trigger garbage collection in the memory sub-system.

9. The method of claim 4, wherein the operations further include:
determining, by the host system, a first logical address having a storage space implemented in the first reclaim unit;
sending a read command from the host system to the memory sub-system to retrieve, from the first logical address, first data; and
sending a write command from the host system to the memory sub-system to write the first data back to the first logical address to cause the first data as stored in the first reclaim unit to be invalidated.

10. The method of claim 4, further comprising:
sending a garbage collection control release from the host system to the memory sub-system to cause the memory sub-system to select, after an indicator of usage level of storage resources in the memory sub-system reaches a predetermined condition, victim reclaim units for garbage collection.

11. A computing system, comprising:
a host system; and
a memory sub-system connected to the host system;
wherein the memory sub-system is configurable to be prevented from selecting victim reclaim units for garbage collection.

12. The computing system of claim 11, wherein the host system is configured to identify a first reclaim unit having residual valid data, and perform operations to cause the residual valid data to be invalidated in the first reclaim unit;
wherein the memory sub-system is configured to erase the first reclaim unit in response to a determination that no valid data remains in the first reclaim unit; and
wherein the memory sub-system is operable to receive a garbage collection control request from the host system to be prevented from selecting victim reclaim units for garbage collection.

13. The computing system of claim 12, wherein the host system is further configured to send a folding request to a storage space tenant to accelerate invalidation of data at a logical address having a storage space implemented in the first reclaim unit.

14. The computing system of claim 13, wherein the folding request causes the storage space tenant to generate a command to deallocate the logical address, to overwrite at the logical address, or to delete data from the logical address.

15. The computing system of claim 14, wherein the operations further include sending a garbage collection request to identify the first reclaim unit to the memory sub-system;
wherein the garbage collection request causes the memory sub-system to copy remaining valid data from the first reclaim unit to a second reclaim unit to invalidate the remaining valid data stored in the first reclaim unit; and
wherein the garbage collection request includes a data placement directive used by the memory sub-system to identify the second reclaim unit for storing the remaining valid data copied from the first reclaim unit.

16. The computing system of claim 15, wherein the memory sub-system is further configured to:
enter an identification of the first reclaim unit into a garbage collection queue; and
postpone processing requests in the garbage collection queue to after an indicator of usage level of storage resources in the memory sub-system reaches a predetermined condition.

17. The computing system of claim 15, wherein the memory sub-system is further configured to process the garbage collection request for erasure of the first reclaim unit without waiting for an indicator of usage level of storage resources in the memory sub-system to reach a predetermined condition configured to trigger garbage collection in the memory sub-system.

18. A non-transitory computer storage medium storing instructions that, when executed in a computing system having a host system connected to a memory sub-system, cause the computing system to perform a method, comprising:
configuring the memory sub-system to prevent the memory sub-system from selecting victim reclaim units for garbage collection;
identifying, by the host system connected to the memory sub-system, a first reclaim unit having residual valid data; and
performing, by the host system, operations to cause the residual valid data to be invalidated in the first reclaim unit.

19. The non-transitory computer storage medium of claim 18, wherein the method further comprises:
erasing, by the memory sub-system, the first reclaim unit in response to a determination that no valid data remains in the first reclaim unit;
determining, by the host system, a first logical address having a storage space implemented in the first reclaim unit;
sending a read command from the host system to the memory sub-system to retrieve, from the first logical address, first data; and
sending a write command from the host system to the memory sub-system to write the first data back to the first logical address to cause the first data as stored in the first reclaim unit to be invalidated.

20. The non-transitory computer storage medium of claim 18, wherein the method further comprises:
sending a garbage collection control release from the host system to the memory sub-system to cause the memory sub-system to select, after an indicator of usage level of storage resources in the memory sub-system reaches a predetermined condition, victim reclaim units for garbage collection.
